(19) United States
(12) Patent Application Publication
(10) Pub. No.: US 2006/0246330 A1
(43) Pub. Date: Nov. 2, 2006

(54) Fuel cell system

(75) Inventors: Hidehiko Hiramatsu, Nagoya (JP); Takeshi Yamamoto, Ama-gun (JP); Shingo Morishima, Toyota-shi (JP)

Correspondence Address: OLIFF & BERRIDGE, PLC, P.O. BOX 19928, ALEXANDRIA, VA, 22320, US

(73) Assignee: Denso Corporation, Kariya-city (JP)

(21) Appl. No.: 11/410,159

(22) Filed: Apr. 25, 2006

(30) Foreign Application Priority Data
Apr. 27, 2005 (JP) 2005-129055

(51) Int. Cl. H01M 8/04

(52) U.S. Cl. 429/22; 429/34; 429/25; 429/17

(57) ABSTRACT

A fuel cell system performing a pre-process for electric generation in a fuel cell controls at least one of a flow amount of fuel gas flowing through a fuel gas supply path and a flow amount of off gas flowing through an off gas circulation path in order to regulate a circulation ratio of a mixed gas composed of the fuel gas and the off gas. The circulation ratio is a ratio between a mole flow amount of the off gas to a mole flow amount of the fuel gas. Before initiating usual electric generation of the fuel cell, the fuel cell system performs the pre-process in which the fuel gas is supplied to the fuel cell in order to set the circulation ratio within a predetermined range. The lower limit of the circulation ratio is set to a value by which all initial gas in a fuel electrode of the fuel cell before initiating the pre-process is exhausted completely. The upper limit of the circulation ratio is set so that a gas concentration of the mixed gas required to initiate the electric generation in the fuel cell is obtained.

### CROSS-REFERENCE TO RELATED APPLICATIONS

This application is related to and claims priority from Japanese Patent Application No. 2005-129055 filed on Apr. 27, 2005, the contents of which are hereby incorporated by reference.

### BACKGROUND OF THE INVENTION

1. Field of the Invention

The present invention relates to a fuel cell system equipped with a fuel cell (FC stack) capable of generating electrical energy in electrochemical reaction by combining hydrogen and oxygen, and in particular, relates to a fuel cell system equipped with a fuel cell as an electric power source which is suitably applicable to movable bodies such as an automotive vehicles, an electric vehicle, a marine vessel, portable power generators, small-sized generators for home use, and other mobile devices.

2. Description of the Related Art

During a halt of operation of a fuel cell, it is preferred to fill a hydrogen electrode end (or a fuel electrode end) in a fuel cell with air or inactive gas from the viewpoint of safety, durability of electrolyte membrane, and so on. Further, keeping the fuel cell out of operation for a long time causes the hydrogen electrode end (or the fuel electrode end) in the fuel cell to be filled with air that passes through the electrolyte membrane from the air electrode end in the fuel cell even if the hydrogen electrode end in the fuel cell is not replaced with air. Accordingly, in order to initiate the electric generation of the fuel cell, it is necessary to replace the air filled in the hydrogen electrode end with the hydrogen gas rapidly.

In order to solve such a demand, a Japanese patent laid open publication number JP 2003-157875 disclosed a following conventional manner. In a fuel cell system in which an off gas exhausted from a hydrogen electrode is circulated by an ejector, a fuel gas is supplied at the start-up timing of the fuel cell into a region, where the ejector occurs a back-flow or back-streaming, so as to exhaust the gas through a purge valve and to replace the gas in the circulation path with hydrogen gas.

Another Japanese patent laid open publication number JP 2003-331888 disclosed a following conventional manner. A hydrogen replacement valve of a larger opening size than that of a purge valve is mounted on an off gas circulation path through which the off gas emitted from the hydrogen electrode flows and circulated. The hydrogen replacement valve is open at the start-up of the fuel cell and in order to keep a supply amount of the hydrogen gas constant, the hydrogen gas is also discharged through the hydrogen replacement valve while supplying the hydrogen gas into the fuel cell.

However, those conventional manners and techniques disclosed by the Japanese patent laid open publication numbers JP 2003-157875 and JP 2003-331888 involve a drawback or problem in which hydrogen gas of a high concentration is exhausted from the fuel cell to the outside of the fuel cell or fuel cell system when the fuel cell is restarted immediately following a temporary halt of the fuel cell because the high concentration hydrogen gas still remains in the hydrogen electrode of the fuel cell. This brings a problem in safety.

### SUMMARY OF THE INVENTION

It is an object of the present invention to provide a new and improved fuel cell system equipped with a fuel cell, the fuel cell system is capable of preventing exhaust remaining gases in a fuel electrode of the fuel cell to the outside of the fuel cell system at the start-up of electric generation of the fuel cell system, and capable of supplying a fuel gas to the fuel cell in order to enter the fuel cell into ready condition for electric generation.

To achieve the above object, according to one aspect of the present invention, there is provided a fuel cell system having a fuel cell, a fuel gas supply path, an off gas circulation path, off gas circulation means, circulation ratio adjusting means. The fuel cell is configured to generate electric generation in electrochemical reaction by combining fuel gas and oxygen gas. The fuel gas supply path is joined to an inlet of the fuel cell. Through the fuel gas supply path, the fuel gas is supplied to the fuel cell. The off gas circulation path joins an outlet of the fuel cell to the fuel gas supply path. Through the outlet of the fuel cell, an off gas in a fuel electrode of the fuel cell is exhausted. The off gas circulation means is configured to circulate the off gas from the fuel electrode of the fuel cell to the fuel gas supply path. The circulation ratio adjusting means is configured to adjust a circulation ratio of a mole flow of the fuel gas to a mole flow of the off gas by controlling at least one of a fuel gas flow amount and an off gas flow amount so that the circulation ratio is set to a predetermined circulation ratio during a pre-process for the electric generation of the fuel cell in order to exhaust all of residual gas in the fuel electrode of the fuel cell remained before initiating the pre-process.

According to another aspect of the present invention, there is provided a fuel cell system having a fuel cell, a fuel gas supply path, an off gas circulation path, an off gas circulation unit, and a circulation ratio adjusting unit. In the fuel cell system, the fuel cell is configured to generate electric generation in electrochemical reaction by combining fuel gas and oxygen gas. Through the fuel gas supply path, the fuel gas is supplied to a fuel electrode of the fuel cell. The off gas circulation path, through which an outlet of the fuel electrode of the fuel cell is joined to the fuel gas supply path, is configured to provide off gas exhausted from the fuel electrode of the fuel cell to the fuel gas supply path in order to mix the off gas into the fuel gas. The off gas circulation unit is configured to circulate the off gas through the off gas circulation path. The circulation ratio adjusting unit is configured to adjust a circulation ratio of a mole flow of the fuel gas flowing through the fuel gas supply path to a mole flow of the off gas flowing through the off gas circulation path by controlling at least one of the fuel gas flow amount and the off gas flow amount. In the fuel cell system, the off gas exhausted from the fuel electrode of the fuel cell is supplied to the fuel gas supply path through the off gas circulation path and mixed to the fuel gas and supplied to the fuel cell. The circulation ratio adjusting unit is configured to perform a pre-process, before initiating the electric generation by the fuel cell, in which the fuel gas is supplied to the fuel cell so that the circulation ratio is set to a predetermined circulation ratio. A lower limit of the predetermined circulation ratio is set to a value by which all of remaining gas in the fuel electrode of the fuel cell can be exhausted by supplying the fuel gas to the fuel cell before initiating the electric generation of the fuel cell.

According to the configuration of the fuel cell system of the present invention, it is possible to replace initial gas in the fuel electrode (such as hydrogen electrode) of the fuel cell with the fuel gas (such as hydrogen gas) while circulating the initial gas, involved in the fuel electrode before the pre-process, through the off gas circulation path and while preventing the emission or exhaustion of the initial gas such as nitrogen rich gas to the outside of the fuel cell system. It is thereby possible to initiate the electric generation of the fuel cell at a short time. This can prevent that the fuel gas is exhausted to the outside of the fuel cell system even if the fuel gas is remained in the fuel electrode immediately following a temporary halt of the electric generation.

The lower limit of the predetermined range of the circulation ratio is set to a value by which all of gases in the fuel electrode of the fuel cell are exhausted from the fuel electrode of the fuel cell by introducing the fuel gas to the fuel cell before initiating the pre-process for the electric generation. This can prevent unstable electric generation caused by the presence of remaining initial gas in the fuel electrode of the fuel cell before initiating the electric generation.

The lower limit of the circulation ratio is determined based on a volume of the fuel gas supply path including a volume of the fuel electrode in the fuel cell and a supply pressure of the fuel gas to be supplied to the fuel cell when the pre-process is initiated.

Still further, according to another aspect of the present invention, there is provided a method of performing a pre-process for electric generation in a fuel cell system equipped with a fuel cell. The method has steps of performing a pre-process, before initiating usual electric generation of the fuel cell, and then performing the usual electric generation after the completion of the pre-process. In the pre-process, off gas emitted from a fuel electrode of the fuel cell and fuel gas to be supplied to the fuel gas are mixed, and the mixed gas is supplied to the fuel cell at a predetermined circulation ratio while controlling at least one of a flow amount of the fuel gas and a flow amount of the off gas. In the method, the circulation ratio is a ratio of a mole flow of the fuel gas to a mole flow of the off gas in order to exhaust all of residual gas in the fuel electrode of the fuel cell remained before initiating the pre-process.

### BRIEF DESCRIPTION OF THE DRAWINGS

A preferred, non-limiting embodiment of the present invention will be described by way of example with reference to the accompanying drawings, in which:

FIG. 1 is a schematic diagram showing a configuration of a fuel cell system according to a first embodiment of the present invention;

FIG. 2 is a schematic diagram showing a gas flow in a hydrogen supply path divided into plural paths for unit cells forming the fuel cell and an off gas circulation path in the fuel cell system according to the first embodiment;

FIG. 3 is a diagram showing a relationship between an introduction pressure of hydrogen gas to be supplied to the fuel cell and a lower limit of a circulation ratio B/A in the fuel cell system according to the first embodiment;

FIG. 4 is a diagram showing a relationship between nozzle opening of an ejector pump or ejector and a circulation ratio B/A in the fuel cell system according to the first embodiment;

FIG. 5 is a diagram showing a relationship between a composition of mixed gas composed of two gases, hydrogen gas and nitrogen gas, and a coefficient of viscosity of the mixed gas in the fuel cell system according to the first embodiment;

FIG. 6 is a schematic diagram showing a fuel cell system according to a second embodiment of the present invention;

FIG. 7 is a diagram showing a relationship between a primary pressure of an ejector pump and a circulation ratio B/A in the fuel cell system according to the second embodiment;

FIG. 8 is a diagram showing a relationship between nozzle opening and a primary pressure of an ejector pump, and a relationship between the primary pressure of the ejector pump and a circulation ratio B/A in a fuel cell system according to a third embodiment;

FIG. 9 is a schematic diagram showing a fuel cell system according to a fourth embodiment of the present invention;

FIG. 10 is a diagram showing a relationship between opening time of nozzle opening of an ejector pump and opening time of a shut valve mounted on a bypass in the fuel cell system according to the fourth embodiment.

FIG. 11 is a schematic diagram showing a fuel cell system according to a fifth embodiment of the present invention;

FIG. 12 is a schematic diagram showing a fuel cell system according to a sixth embodiment of the present invention;

FIG. 13 is a schematic diagram showing a fuel cell system according to a seventh embodiment of the present invention;

FIG. 14 is a schematic diagram showing a fuel cell system according to an eighth embodiment of the present invention;

FIG. 15 is a diagram showing a relationship between an introduction pressure of hydrogen gas to be supplied to a fuel cell and a lower limit of a circulation ratio B/A of the hydrogen gas in the fuel cell system according to the eighth embodiment; and

FIG. 16 is a diagram showing a relationship between nozzle opening of a nozzle and a primary pressure of an ejector pump, and a relationship between the primary pressure of the ejector pump and a circulation ratio B/A in the fuel cell system according to eighth embodiment.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

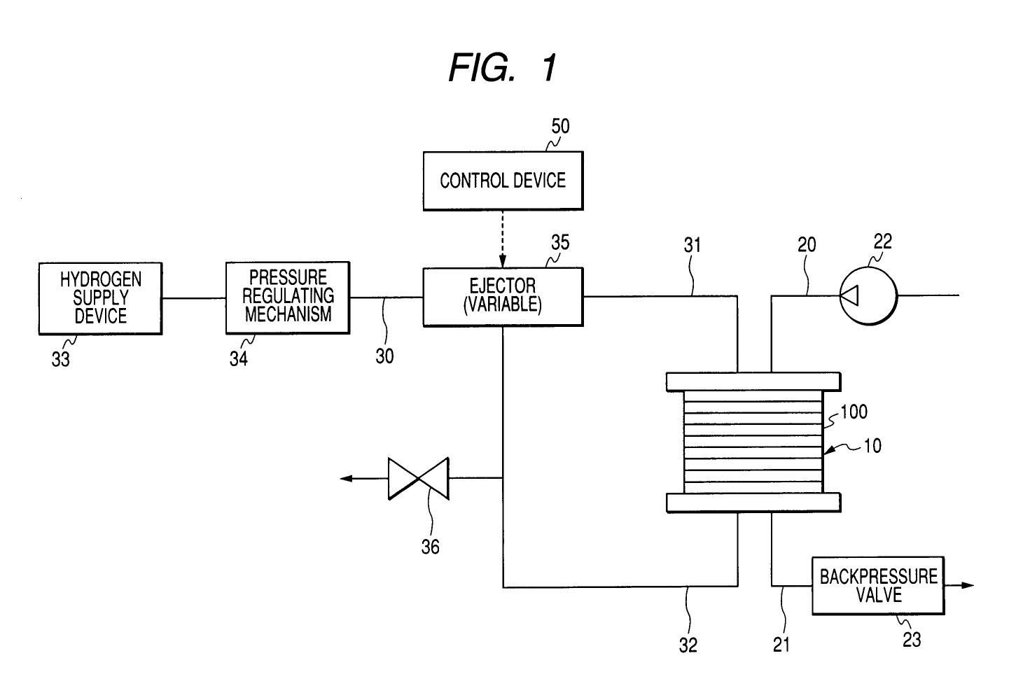

A description will now be given of a configuration, operation, and features of the fuel cell system according to the first embodiment of the present invention with reference to FIG. 1 to FIG. 5.

FIG. 1 shows the entire configuration of the fuel cell system of the first embodiment according to the present invention. In FIG.1, the fuel cell system has a fuel cell (FC stack) 10 that generates electrical energy in an electrochemical reaction of hydrogen and oxygen. The fuel cell 10 supplies the generated electrical energy to a motor mounted on a vehicle, a secondary battery, and supplementary electrical equipments (omitted from drawings).

In a case of the first embodiment, the fuel cell 10 is a polymer electrolyte fuel cell (PEFC) in which a plurality of unit cells are laminated and stacked in multilayered structure. Each unit cell has a configuration in which an electrolyte membrane is sandwiched between a pair of separators. Each cell generates electrical energy by an electrochemical reaction of hydrogen and oxygen.
Hydrogen electrode: H₂→2H⁺+2e⁻, and
Oxygen electrode: 2H⁺+½O₂+2e⁻→H₂O.

A usual fuel cell system is equipped with an air supply path 20 through which air (oxygen) is supplied to the fuel cell 10 and an air exhaust path 21 through which the air from the fuel cell 10 is exhausted to the outside of the fuel cell system.

The air supply path 20 is equipped with an air supply device 22 that compresses the air and supplies the compressed air to the fuel cell 10. In the embodiment, the air supply device 22 is implemented by a compressor, for example. The air exhaust path 21 is equipped with a backpressure valve 23 which is capable of regulating an air pressure in the fuel cell 10 by adjusting a flow sectional area of the air exhaust path 21.

The fuel cell system of the embodiment is further equipped with hydrogen supply paths 30 and 31 and an off gas circulation path 32. Through the hydrogen supply paths 30 and 31 hydrogen gas as a fuel gas is supplied from a hydrogen supply device 33 to the fuel cell 10. Through the off gas circulation path 32 the off gas containing residual hydrogen gas which has not been reacted during the electrochemical reaction in the fuel cell 10 is circulated and supplied again to the fuel cell 10.

The off gas circulation path 32 joins the outlet end of the hydrogen electrode of the fuel cell 10 to the hydrogen supply paths 30 and 31. The hydrogen supply paths 30 and 31 are divided into two paths such as the first hydrogen supply path 30 in the upstream end and the second hydrogen supply path 31 in the downstream end of the hydrogen supply path. Only hydrogen gas supplied from the hydrogen supply device 33 (or a hydrogen gas tank) flows through the first hydrogen supply path 30.

The hydrogen gas, supplied from the hydrogen supply device 33, and the off gas, to be circulated through the off gas circulation path 32 flow into the fuel cell 10 through the second hydrogen supply path 31.

The first hydrogen supply path 30 is equipped with or joined to the hydrogen supply device 33 and a pressure regulating mechanism 34. In this embodiment, a high-pressure hydrogen tank filled with high-pressure hydrogen gas is used as the hydrogen supply device 33. The pressure regulating mechanism 34 has a pressure regulator valve to regulate the pressure of the hydrogen gas to be supplied to the fuel cell 10. In the embodiment, the pressure regulating mechanism 34 is capable of providing the hydrogen gas of a supply pressure 300 kPa·abs to the fuel cell 10 through an ejector pump 35.

This ejector pump 35 is installed in a junction of the hydrogen supply path 30, the off gas circulation path 31, and the off gas circulation path 32 in order to circulate the off gas flowing through the off gas circulation path 32 to the fuel cell 10. The ejector pump 35 ejects the hydrogen gas at a high speed supplied from the hydrogen supply device 33 so as to generate a negative pressure. The negative pressure generated sucks the off gas supplied from the off gas circulation path 32. The ejector pump 35 mixes the hydrogen gas from the hydrogen supply device 33 and the off gas from the off gas circulation path 32, and supplies the mixed gas of the hydrogen gas and the off gas to the second hydrogen path 31 which is jointed to the fuel cell 10. The ejector pump 35 is capable of adjusting the amount of the off gas circulation flow by changing the amount of the hydrogen gas which is changed by adjusting the nozzle opening or the supplying pressure (as a primary pressure of the ejector pump 35) of the hydrogen gas to be supplied to the ejector pump 35. The ejector pump 35 in the fuel cell system according to the embodiment is configured to adjust the amount of the off gas flowing through the off gas circulation path 32 by adjusting the nozzle opening by an actuator (omitted from diagrams).

As shown in FIG. 1, the off gas circulation path 32 is equipped with a purge valve 36 through which the off gas to be circulated is exhausted to the outside of the fuel cell system. Impure materials such as nitrogen are accumulated in the gas in the hydrogen electrode end of the fuel cell 10 in the course of operation of the fuel cell 10. This increases the impurity concentration in the off gas emitted from the fuel cell 10 and thereby decreases the hydrogen concentration in the gas. In order to avoid this phenomenon, the purge valve 36 opens at an optional timing during the operation of the fuel cell 10 in order to exhaust a part of the off gas of a low hydrogen concentration to the outside of the fuel cell system.

The fuel cell system of the embodiment is further equipped with a control device 50 (or a controller) that performs various arithmetic processes and generates and outputs control signals. The control device 50 comprises an available microcomputer and peripheral circuits. The microcomputer is generally composed of a central processing unit (CPU), a read only memory (ROM), a random access memory (RAM) and so on. The control device 50 is configured to generate and output a control signal to the ejector pump 35. The ejector pump 35 receives the control signal transferred from the control device 50 and adjusts its nozzle opening based on the control signal in order to adjust the amount of the off gas flowing through the off gas circulation path 32. The control device 50 further generates and outputs control signals (omitted from drawings) to an air supply device 22, a backpressure valve 23, the hydrogen supply device 33, the purge valve 36 and others configuration elements (omitted from drawings) in the fuel cell system. Those components are configured to operate based on the control signals transferred from the control device 50.

In the fuel cell system of the first embodiment, the ejector pump 35 and the control device 50 correspond to a circulation ratio adjusting means defined in claims.

Next, a description will now be given of the operation of a pre-process for the electric generation of the fuel cell 10 in the fuel cell system according to the first embodiment.

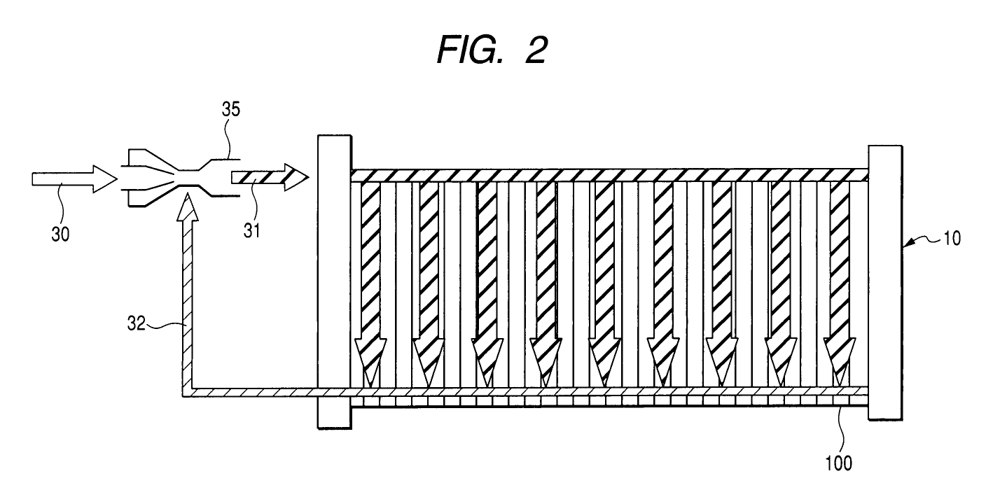

FIG. 2 is a schematic diagram showing the gas flow in the hydrogen supply paths 30, 31 and the off gas circulation path 32 in the fuel cell system according to the first embodiment. As shown in FIG. 2, the fuel cell 10 comprises a plurality of unit cells 100 which are laminated, in general, approximately 100 to 400 unit cells. The fuel gas (or hydrogen gas) supplied to the fuel cell 10 is branched or divided into each unit cell 100.

Because air (as nitrogen rich gas, or initial gas) of the atmospheric pressure is filled with the hydrogen electrode during a halt of the operation of the fuel cell 10, in order to re-start the electric generation of the fuel cell 10, it is necessary to exhaust the air (as initial gas) and to fill the hydrogen electrode with the hydrogen gas in order to replace the air (or the initial gas) with the hydrogen gas (or the fuel gas). Accordingly, the fuel cell system of the first embodiment performs the pre-process for the electric generation to exhaust the initial gas (or the nitrogen rich gas) at the hydrogen electrode end of the fuel cell 10 by supplying the hydrogen gas through the hydrogen supply paths 30 and 31 to the fuel cell 10.

The nitrogen rich gas exhausted from the fuel cell 10 in the pre-process for the electric generation flows through the off gas circulation path 32 and reaches to the second hydrogen supply path 31 joined to the inlet of the fuel cell 10. The nitrogen rich gas is thereby mixed with the hydrogen gas supplied from the first hydrogen supply paths 30 and then supplied to the fuel cell 10 by the ejector pump 35. The fuel cell system according to the first embodiment of the present invention controls so that a circulation ratio B/A is set within a predetermined range, for example, within 0.2 to 1.0 in the first embodiment, where A is a mole flow of the gas flowing in the second hydrogen supply path 31 and B is a mole flow of the gas flowing in the off gas circulation path 32.

Next, the lower limit of the circulation ratio B/A will be explained.

When the circulation ratio B/A takes a small value, the amount of the circulation flow of the off gas flowing through the off gas circulation path 32 becomes insufficient, and the amount of exhaust of the nitrogen rich gas in the hydrogen electrode of the fuel cell 10 becomes insufficient. This causes the residual nitrogen rich gas at the peripheral area of the hydrogen electrode of the fuel cell 10. This further cause the insufficient mixed gas supplied to the unit cells 100 where the residual nitrogen rich gas still remains. As a result, the unit cell 100 has the insufficient hydrogen gas and the residual nitrogen rich gas. On initiating the electric generation of the fuel cell 10 under this condition, the fuel cell system performs unstable electric generation because of the insufficient hydrogen gas in the unit cells 100. In order to avoid the unstable electric generation, it is necessary to exhaust all of the residual nitrogen rich gas in the fuel cell 10 when the hydrogen gas is supplied to the fuel cell 10 at the initiation of the electric generation in the fuel cell 10.

Therefore the lower limit of the circulation ratio B/A is set to a circulation ratio by which the all amount of the nitrogen rich gas in the hydrogen electrode is exhausted completely before initiating the electric generation of the fuel cell 10. In a concrete example, the lower limit of the circulation ratio B/A is determined based on a volume of the second hydrogen supply path 31, a volume of the off gas circulation path 32, and a supply pressure of the hydrogen gas to be supplied to the fuel cell 10 at the start of the electric generation of the fuel cell 10, where the volume of the second hydrogen supply path 31 is designated by bold slant lines shown in FIG. 2, namely, the volume includes both the volume of manifold at the hydrogen inlet end (or the inlet) of the fuel cell 10 and the volume of the hydrogen electrode. The volume of the off gas circulation path 32 is designated by fine slant lines shown in FIG. 2, namely the volume includes the volume of manifold of the hydrogen outlet end of the fuel cell 10.

When the volume of the second hydrogen supply path 31 is larger than that of the off gas circulation path 32, it is necessary to take a large circulation ratio B/A because of the necessity for exhausting a large amount of gas from the hydrogen electrode end of the fuel cell 10. On the contrary, when the volume of the second hydrogen supply path 31 is smaller than that of the off gas circulation path 32, it is necessary to take a small circulation ratio B/A because of the necessity for exhausting a small amount of gas from the hydrogen electrode end of the fuel cell 10.

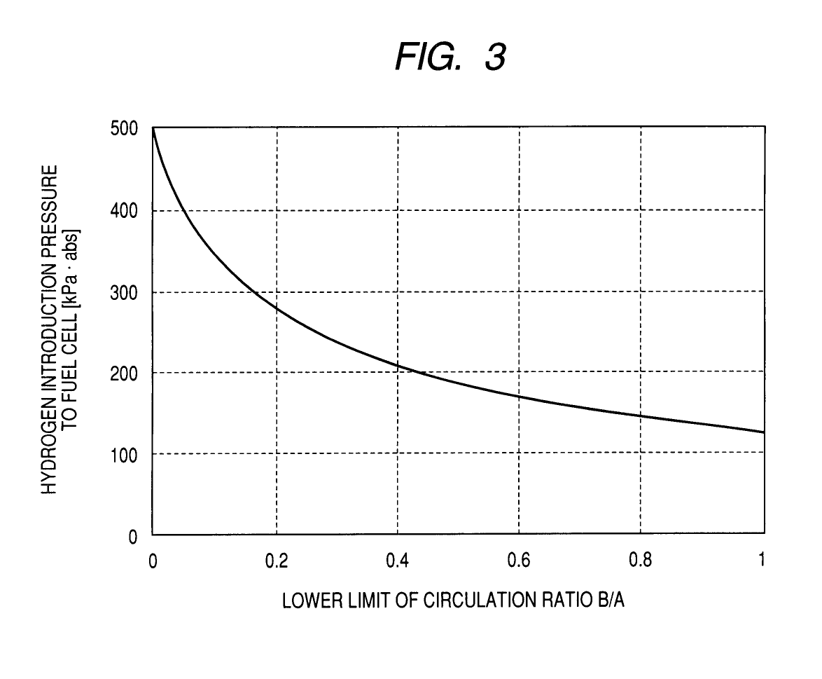

FIG. 3 is a diagram showing a relationship between an introduction pressure of the hydrogen gas to be supplied to the fuel cell 10 and the lower limit of the circulation ratio B/A in the fuel cell system according to the first embodiment.

FIG. 3 shows a case where the volume of the volume of the mixed gas supply path 31 (namely, the second hydrogen supply path 31) including the volume of the hydrogen electrode of the fuel cell 10 is five liters (5 liters) and the volume of the off gas circulation path 32 is 0.3 liters. In the case shown in FIG. 3, on initiating the operation of the fuel cell 10, the necessary circulation ratio B/A becomes approximately 0.5 when the hydrogen introduction pressure is 200 kPa·abs, and the necessary circulation ratio B/A becomes approximately 0.2 when 300 kPa·abs.

Next, a description will be given of the upper limit of the circulation ratio B/A in the fuel cell system of the first embodiment.

If the circulation ratio B/A is a larger value, the amount of the nitrogen rich gas exhausted from the hydrogen electrode of the fuel cell 10 becomes large, as a result, the nitrogen concentration in the mixed gas to be supplied to the fuel cell 10 becomes high and on the contrary, the hydrogen concentration thereof becomes low. This causes the unstable electric generation because of the insufficient of the amount of the hydrogen gas.

In order to avoid this, the upper limit of the circulation ratio B/A is determined based on the hydrogen concentration required for performing stable electric generation in the fuel cell 10. For example, the upper limit of the circulation ration B/A becomes one when the hydrogen concentration required for performing the stable electric generation is a value of not less than 50 percent of the mixed gas to be supplied from the second hydrogen supply path 31.

Next, a description will now be given of the adjusting manner of the circulation ratio B/A in the fuel cell system of the first embodiment.

The ejector pump 35 is capable of regulating the amount of gas flowing in the off gas circulation path 32 by changing its nozzle opening even if the hydrogen pressure (as the primary pressure of the ejector pump 35) flowing through the first hydrogen supply path 30 from the pressure regulating mechanism 34 is constant. It is possible to adjust the circulation ratio B/A by changing the nozzle opening of the ejector pump 35.

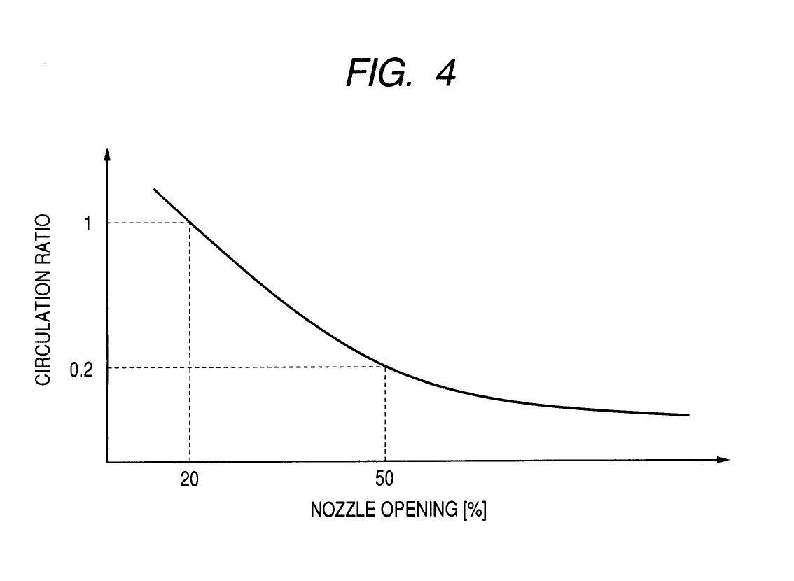

FIG. 4 shows a relationship between the nozzle opening of the ejector pump 35 and the circulation ratio B/A in the fuel cell system according to the first embodiment. As shown in FIG.4, the ejector pump 35 in the fuel cell system of the first embodiment takes the circulation ratio B/A of 1 under the condition of the nozzle opening of 20 percent, and the circulation ratio B/A of 0.2 under the condition of the nozzle opening of 50 percent. Accordingly, it is possible to set the circulation ratio B/A within 0.2 to 1 when the nozzle opening of the ejector pump 35 is set within 20 to 50 percentages.

In the initial state before the start-up of the fuel cell 10, the second hydrogen supply path 31 and the hydrogen electrode of the fuel cell 10 are filled with air from the atmospheric pressure. In the first embodiment, the nozzle opening of the ejector pump 35 is set to 40 percent at the pre-process of the electric generation of the fuel cell 10, and the hydrogen gas is then supplied from the hydrogen supply device 33 to the hydrogen electrode of the fuel cell 10 until the hydrogen concentration becomes not less than 50 percent and the hydrogen pressure becomes not less than 300 kPa·abs. This pre-process for the electric generation of the fuel cell 10 is performed for a predetermined time period. This predetermined time period is the time until the pressure of the hydrogen gas supplied to the hydrogen electrode of the fuel cell 10 reaches an initiation supply pressure. That is, the predetermined time period is determined based on the supply amount of the hydrogen gas to be supplied to the fuel cell 10, the volume of the second hydrogen supply path 31 designated by bold slant lines shown in FIG. 2, and the volume of the off gas circulation path 32 designated by fine slant lines shown in FIG. 2. After the elapse of the predetermined time period counted from the initiation of the pre-process for the electric generation, the fuel cell 10 initiates the electric generation operation.

As described above, by performing the pre-process for the electric generation based on the circulation ratio B/A within a predetermined range before the start-up of the fuel cell 10, it is possible to exhaust the initial gas, for example, composed of nitrogen rich gas, from the hydrogen electrode of the fuel cell 10 and to replace it with the hydrogen gas completely, and to start the fuel cell 10 in a short time. According to the fuel cell system of the first embodiment, residual initial gas, for example composed of nitrogen rich gas, in the hydrogen electrode of the fuel cell 10 is not exhausted to the outside of the fuel cell system when the residual gas in the hydrogen electrode of the fuel cell 10 is replaced with the hydrogen gas. Therefore even if the residual initial gas includes the hydrogen gas in the hydrogen electrode immediately following a temporary halt of the electric generation, it is possible to prevent the supply of the hydrogen gas to the outside of the fuel cell system.

Still further, according to the first embodiment, on setting the circulation ratio B/A within a predetermined range, approximately 0.2 to 1.0 at the start-up of the fuel cell 10, the nitrogen rich gas in the hydrogen electrode in the fuel cell 10 is exhausted from the fuel cell 10 (, not exhausted to the outside of the fuel cell system) and then mixed with the hydrogen gas and the mixed gas is supplied to the fuel cell 10. Thus, the initial gas involving the nitrogen rich gas in the first embodiment is not exhausted to the outside of the fuel cell system, but it is exhausted from the hydrogen electrode to the off gas circulation path 32 and mixed with the hydrogen gas supplied from the hydrogen supply device 33. As a result, this increases the coefficient of viscosity of the mixed gas composed of hydrogen gas and nitrogen gas and thereby promotes exhausting the nitrogen rich gas in the hydrogen electrode in the fuel cell 10. This feature will be explained below.

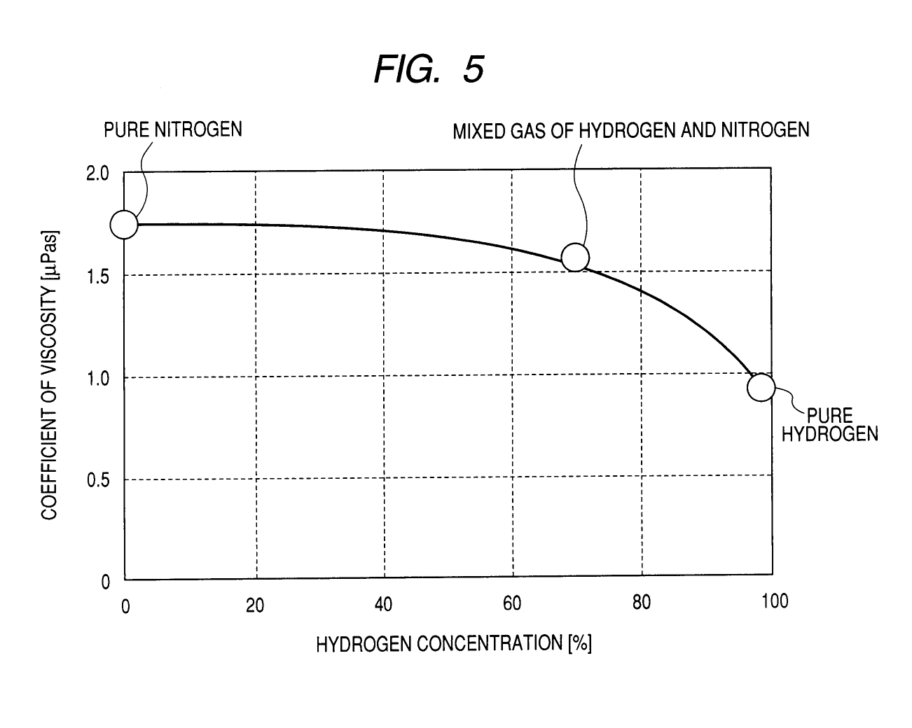

FIG. 5 shows a relationship between a composition of the mixed gas composed of hydrogen gas and nitrogen gas and the coefficient of viscosity of the mixed gas in the fuel cell system according to the first embodiment.

In general, the viscosity of nitrogen is approximately twice that of hydrogen. Because a pressure loss of a laminar flow in a flow path is proportional to a viscosity of gas flow, the pressure loss when the unit cell 100 mainly contains nitrogen becomes approximately twice of the pressure loss under a case that the unit cell 100 mainly contains hydrogen. The amount of gas flow in each unit cell 100 involving mainly hydrogen becomes approximately twice of that in each fuel cell 100 involving mainly nitrogen. Accordingly, the mixed gas flows mainly into unit cell 100 involving hydrogen rich gas having a high concentration of hydrogen.

On initiating the electric generation of the fuel cell 10, the hydrogen gas is introduced into the fuel cell 10, and the unit cells 100 near the inlet end of the hydrogen gas in the fuel cell 10 are firstly filled with the mixed gas. When the mixed gas involves the hydrogen gas of a high concentration, the mixed gas mainly flows into the unit cells 100 near the inlet end of the fuel cell 10. On the contrary, it is difficult to replace the nitrogen rich gas with the hydrogen gas in the unit cells 100 apart from the inlet end of the fuel cell 10. This causes that each unit cell 100 has a different hydrogen concentration, in other words, the variation of the hydrogen concentration occurs between the unit cells 100.

In order to avoid this phenomenon, according to the fuel cell system of the first embodiment of the present invention, on initiating the electric generation of the fuel cell 10, the circulation ratio B/A is set within approximately 0.2 to 1.0, and the velocity of the mixed gas to be supplied to the fuel cell 10 becomes high because hydrogen gas is mixed with nitrogen gas. Thereby, the velocity of mixed gas to be supplied to the fuel cell 10 becomes approximately equal to the velocity of the nitrogen rich gas in the hydrogen electrode at the initiation or re-start of the electric generation of the fuel cell 10. As a result, the mixed gas is supplied to all of the unit cells 100, near and also apart from the inlet of the fuel cell 10, and uniform distribution of the hydrogen gas to the unit cells 100 can be achieved and each unit cell 100 has the uniform hydrogen concentration.

### Second Embodiment

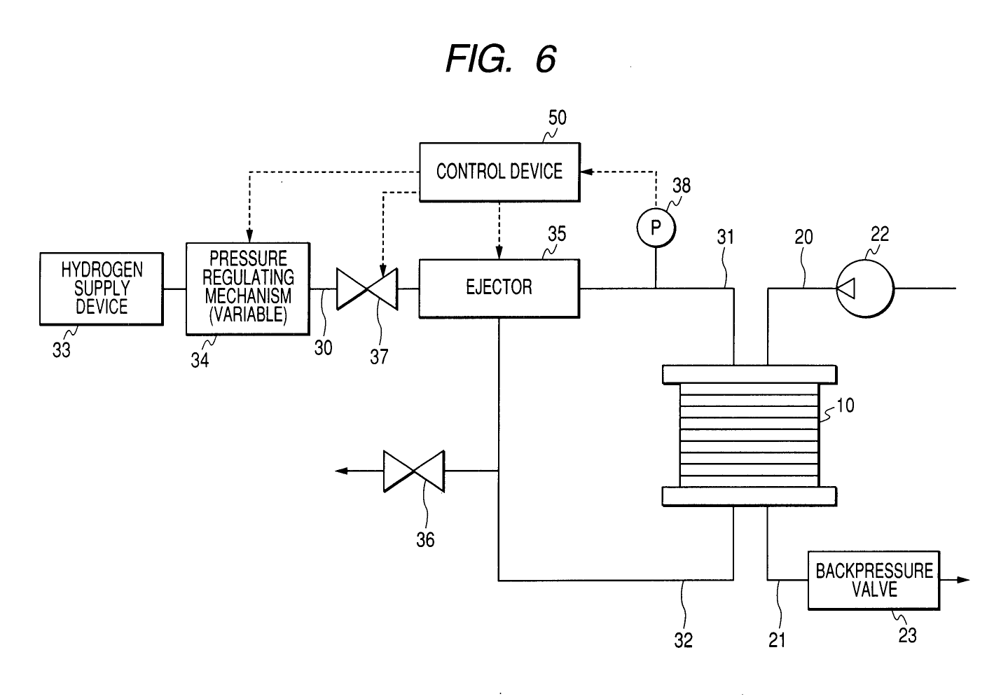

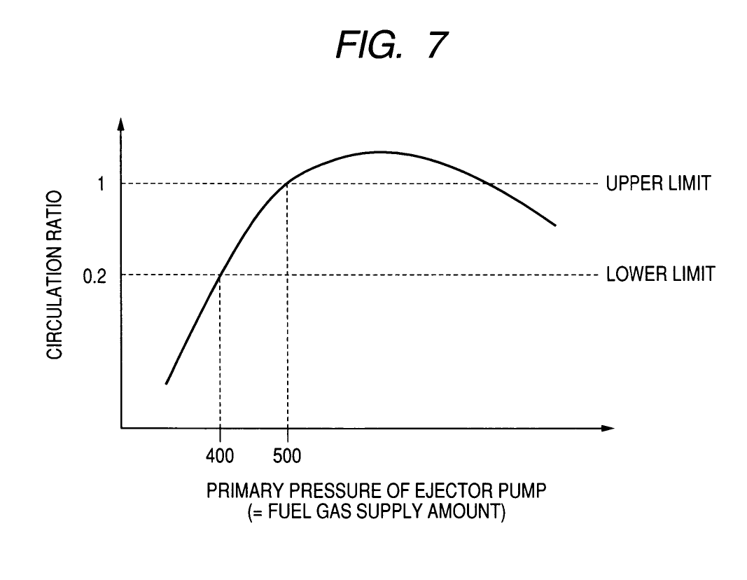

Next, a description will now be given of a configuration and operation of the fuel cell system according to the second embodiment of the present invention with reference to FIG. 6 and FIG. 7.

FIG. 6 is a schematic diagram showing the fuel cell system of the second embodiment. In the second embodiment, the ejector pump 35 has a fixed nozzle opening, and on the contrary, the pressure regulating mechanism 34 has an adjustable valve whose opening is changed so as to regulate the supply pressure of hydrogen gas. The pressure regulating mechanism 34 is configured to regulate the hydrogen supply pressure within 100 to 500 kPa·abs. The fuel cell system of the second embodiment regulates the amount of the off gas flowing through the off gas circulation path 32 by changing the supply pressure (as the primary pressure of the ejector pump 35) of hydrogen gas supplied from the pressure regulating mechanism 34 to the ejector pump 35. Both the pressure regulating mechanism 34 and the ejector pump 35 correspond to a circulation ratio adjusting means defined in claims.

As shown in FIG. 6, a shut valve 37 is mounted between the pressure regulating mechanism 34 and the ejector pump 35 on the first hydrogen supply path 30. The shut valve 37 is configured to open and close the first hydrogen supply path 30. Further, in the configuration of the second embodiment, a pressure sensor 38 is mounted on the second hydrogen supply path 31 and configured to detect the pressure of the gas flowing through the second hydrogen supply path 31. It is also acceptable to mount the pressure sensor 38 on the off gas circulation path 32 instead of on the second hydrogen supply path 31.

The control device 50 is configured to input a sense signal transferred from the pressure sensor 38 and also to generate and output control signals to both the pressure regulating mechanism 34 and the shut valve 37. When receiving the control signal from the control device 50, the pressure regulating mechanism 34 adjusts the hydrogen supply pressure of the hydrogen gas to be supplied to the ejector pump 35 based on the control signal received. When receiving the control signal from the control device 50, the shut valve 37 performs open/close operation of the first hydrogen supply path 30 based on the control signal received.

FIG. 7 is a diagram showing a relationship between the primary pressure of the ejector pump 35 and the circulation ratio B/A in the fuel cell system according to the second embodiment.

As shown in FIG. 7, the circulation ratio B/A becomes 0.2 when the primary pressure of the ejector pump 35 is 400 kPa·abs, and the circulation ratio B/A becomes 1.0 when the primary pressure of the ejector pump 35 is 500 kPa·abs. In order to set the circulation ratio B/A within 0.2 to 1.0, it is therefore necessary for the pressure regulation mechanism 34 to set the primary pressure of the ejector pump 35 within 400 to 500 kPa·abs.

In the fuel cell system of the second embodiment, under the control of the control device 50, the primary pressure of the ejector pump 35 is set to 450 kPa·abs by the pressure regulation mechanism 34 and the shut valve 37 is opened. The hydrogen gas is thereby supplied from the hydrogen supply device 33 and the nitrogen rich gas is exhausted from the hydrogen electrode of the fuel cell 10, and the nitrogen rich gas is replaced with the hydrogen gas in the hydrogen electrode. The hydrogen rich gas is not exhausted to the outside of the fuel cell system. When the pressure of the second hydrogen supply path 31 detected by the pressure sensor 38 reaches to 300 kPa·abs, the control device 50 transfers the control signal to the shut valve 37 in order to close the shut valve 37. The pressure regulation mechanism 34 sets or returns the hydrogen supply pressure to a normal hydrogen supply pressure that is used in usual electric generation, and the control device 35 transfers the control signal to the shut valve 37 so as to open the shut valve 37. The fuel cell system initiates the usual electric generation.

As described above, the fuel cell system of the second invention increases temporarily the primary pressure of the ejector pump 35 so as to increase the amount of the off gas which is not less than that of the usual electric generation of the fuel cell 10.

It is thereby possible to exhaust the initial gas in the hydrogen electrode and replace it with the hydrogen gas while preventing that the initial gas is exhausted to the outside of the fuel cell system. This can start the electric generation of fuel cell 10 at a short time.

When compared with the configuration of the first embodiment for regulating the nozzle opening of the ejector pump 35, the configuration of the fuel cell system of the second embodiment can introduce the hydrogen gas to the fuel cell 10 at a short time.

In addition, according to the second embodiment, the pre-process of the electric generation is stopped or completed when the pressure in the second hydrogen supply path 31 reaches to a predetermined pressure, the primary pressure of the ejector pump 35 can be increased only when the pre-process of the electric generation is performed and the primary pressure of the ejector pump 35 can be decreased during the usual operation of the electric generation. This can increase the safety of the electric generation by the fuel cell system of the second embodiment.

### Third Embodiment

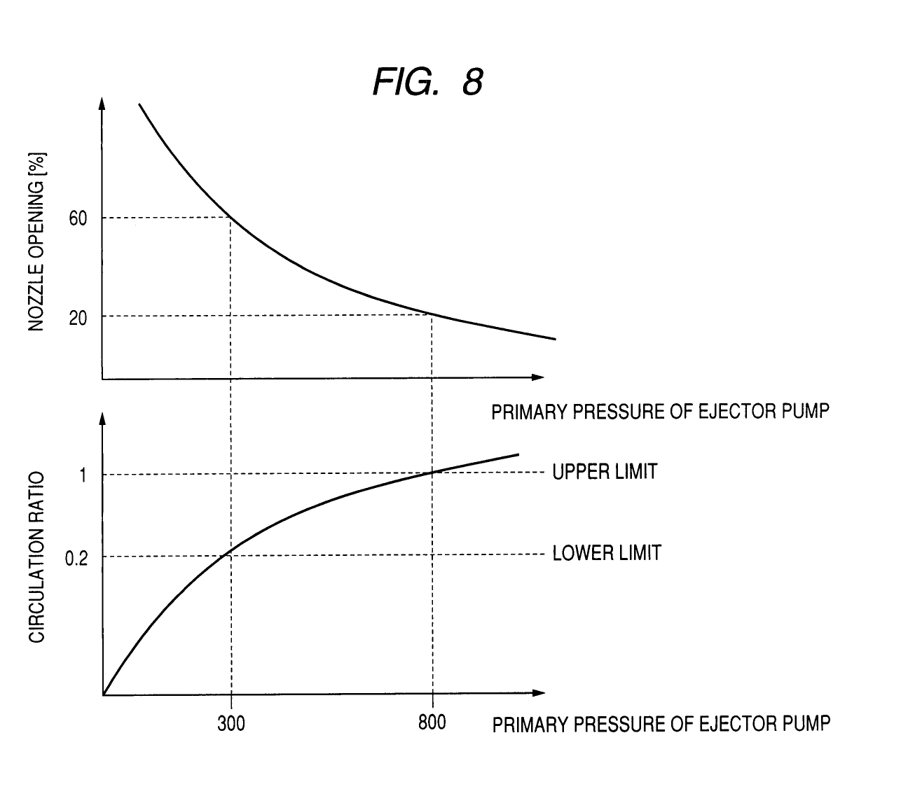

Next, a description will now be given of a configuration and operation of the fuel cell system according to the third embodiment of the present invention with reference to FIG. 8.

In the configuration of the fuel cell system of the third embodiment, in addition to the ejector pump 35 of changeable nozzle opening in the first embodiment, the pressure regulating mechanism 34 is configured, like the second embodiment, to regulate the hydrogen supply pressure of the hydrogen gas to be supplied. That is, the third embodiment has the configuration of both the first embodiment and second embodiment, and the configuration of the fuel cell system of the third embodiment is therefore omitted from the drawings. The pressure regulating mechanism 34 is capable of change the hydrogen supply pressure within 100 to 500 kPa·abs.

In the third embodiment, the circulation ratio B/A can be adjusted by changing the nozzle opening of the ejector pump 35 and further by changing the hydrogen supply pressure of the pressure regulating mechanism 34.

The pressure regulating mechanism 34, the ejector pump 35 and the control device 50 correspond to the circulation ratio adjusting means defined in claims.

FIG. 8 shows a relationship between the nozzle opening of the ejector pump 35 and the primary pressure of the ejector pump 35, and also shows a relationship between the primary pressure of the ejector pump 35 and the circulation ratio B/A in the fuel cell system of the third embodiment. FIG. 8 shows the case that the fuel gas (as hydrogen gas) is supplied to the fuel cell 10 under the gas introduction amount of 500 NL/min (normal liter).

As shown in FIG. 8, in order to set the circulation ratio B/A within 0.2 to 1.0, it is necessary to set the primary pressure of the ejector pump 35 within 300 to 800 kPa·abs. Further, in order to set the fuel gas introduction amount to 500 NL/min under the condition where the primary pressure of the ejector pump 35 is within 300 to 800 kPa·abs, it is therefore necessary to set the nozzle opening of the ejector pump 35 within 20 to 60 percentages.

In the third embodiment, the pressure regulating mechanism 34 sets the primary pressure of the ejector pump 35 to 500 kPa·abs and the nozzle opening of the of the ejector pump 35 to 40 percentages. Under those conditions, the hydrogen gas is supplied from the hydrogen supply device 33 and the pre-process of the electric generation is initiated. The pre-process of the electric generation is stopped after the elapse of the predetermined time. At this time, the nozzle opening of the ejector pump 35 is decreased, and the pressure regulating mechanism 34 decreases the hydrogen supply pressure in order to set the primary pressure of the ejector pump 35 to 300 kPa·abs for performing the usual operation of the electric generation.

As described above, according to the configuration and operation of the fuel cell system of the third embodiment, it is possible to replace the initial gas from the hydrogen electrode of the fuel cell 10 with the hydrogen gas while preventing the emission or exhaustion of the initial gas such as nitrogen rich gas and hydrogen gas to the outside of the fuel cell system, and thereby possible to start the electric generation of the fuel cell 10 in a short time.

### Fourth Embodiment

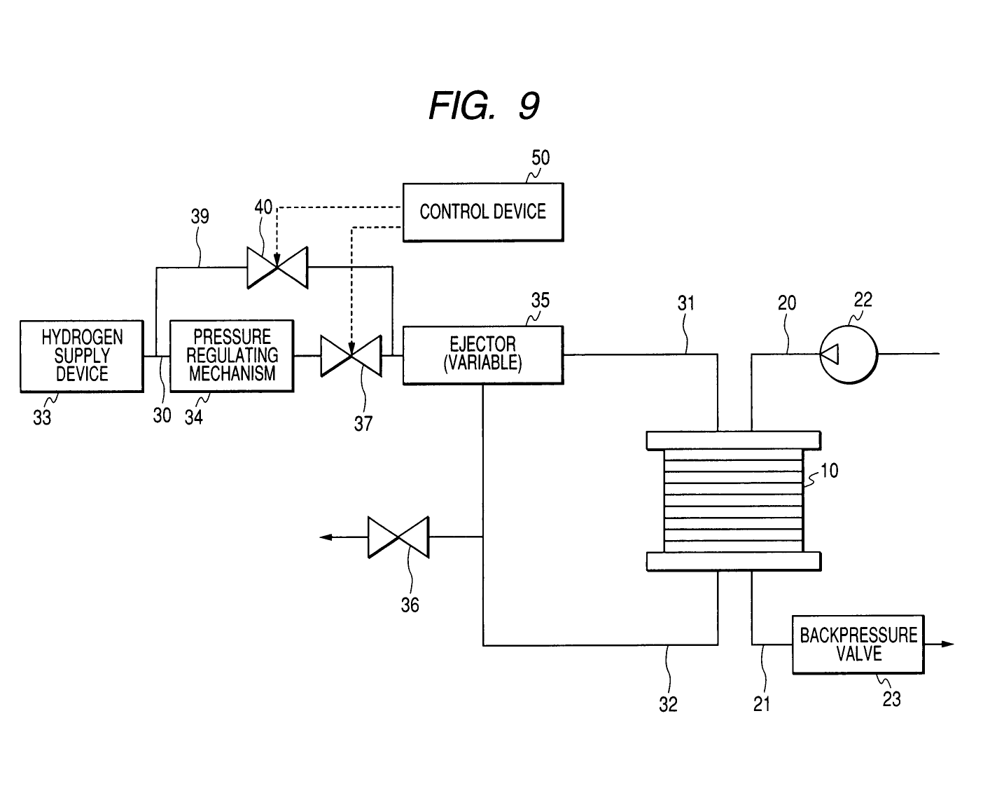

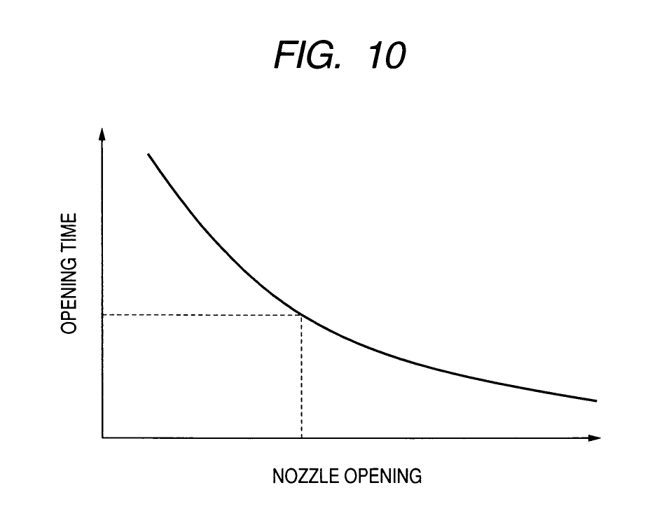

Next, a description will now be given of a configuration and operation of the fuel cell system according to the fourth embodiment of the present invention with reference to FIG. 9 and FIG. 10.

Similar to the first embodiment, the configuration of the fuel cell system of the fourth embodiment provides the ejector pump 35 of changeable nozzle opening. The pressure regulating mechanism 34 of the fourth embodiment is configured to set the hydrogen supply pressure to a fixed value of 300 Pa·abs. It is therefore possible to adjust the circulation ratio by changing the nozzle opening of the ejector pump 35.

The pressure regulating mechanism 34, the ejector pump 35 and the control device 50 correspond to the circulation ratio adjusting means defined in claims.

FIG. 9 is a schematic diagram showing the fuel cell system according to the fourth embodiment of the present invention. As shown in FIG. 9, a bypass 39 is formed or placed between the pressure regulating mechanism 34 and the shut valve 37. Through the bypass 39, the flow of the hydrogen gas supplied from the hydrogen supply device 33 bypasses the pressure regulating mechanism 34 and the shut valve 40. The bypass 39 is equipped with a shut valve 40 as open/close means for open and close the bypass 39. The hydrogen gas supplied from the hydrogen supply device 33 flows only through the first hydrogen supply path 30 when the shut valve 40 is closed under the control device 50. The hydrogen gas supplied from the hydrogen supply device 33 flows through both the first hydrogen supply path 30 and the bypass 39 when the shut valve 40 is opened under the control device 50. When the hydrogen gas supplied from the hydrogen supply device 33 bypasses the pressure regulating mechanism 34, because there is a possibility that the primary pressure of the ejector pump 35 becomes higher than a withstand pressure of the electrolyte membrane of the fuel cell 10, it is necessary to prevent or avoid that an excess pressure is applied to the fuel cell 10 by limiting the opening time of the shut valve 40 mounted on the bypass 39.

FIG. 10 is a diagram showing a relationship between the opening time of nozzle opening of the ejector pump 35 and the opening time of the shut valve 40 mounted on the bypass 39 in the fuel cell system according to the fourth embodiment. As shown in FIG. 10, when the nozzle opening of the ejector pump 35 is larger, the opening time of the shut valve 40 for the bypass 39 becomes short, and on the contrary, when the nozzle opening of the ejector pump 35 is small, the opening time of the shut valve 40 mounted on the bypass 39 becomes long. The relationship between the nozzle opening of the ejector pump 35 and the opening time of the shut valve 40 mounted on the bypass 39 is mapped in advance based on experimental results and result of simulation. Further, the opening time of the shut valve 40 mounted on the bypass 39 is changed according to the volumes of a circulation path composed of the second hydrogen supply path 31 including the hydrogen electrode of the fuel cell 10 and the off gas circulation path 32, the hydrogen pressure at the start-up of the operation of the fuel cell 10, and the primary pressure of the ejector pump 35.

In the fuel cell system of the fourth embodiment, the pre-process for the electric generation is initiated by supplying the hydrogen gas from the hydrogen supply device 33 under the condition of the ejector pump 35 having the nozzle opening of 40 percent. During the pre-process for the electric generation, the shut valve 40 mounted on the bypass 39 is opened for a predetermined time that is set in advance so as to set the primary pressure of the ejector pump 35 to 500 kPa·abs that is higher than the usual pressure 300 kPa·abs of the pressure regulating mechanism 34. After the elapse of the predetermined time counted from the initiation of the pre-process, the pre-process is stopped. At this time, the nozzle opening of the ejector pump 35 is decreased, and the primary pressure of the ejector pump 35 is set or returned to the usual pressure 300 kPa·abs, and the usual electric generation of the fuel cell 10 is then performed.

As described above, according to the configuration of the fuel cell system of the fourth embodiment, like the first to third embodiments, it is possible to replace the residual initial gas in the hydrogen electrode of the fuel cell 10 with the hydrogen gas while preventing the emission or exhaustion of the initial gas such as nitrogen rich gas to the outside of the fuel cell system, and thereby possible to start the electric generation of the fuel cell 10 in a short time.

In addition, according to the configuration of the fuel cell system of the fourth embodiment, because the hydrogen gas supplied from the hydrogen supply device 33 bypasses the pressure regulating mechanism 34, mounted on the first hydrogen supply path 30, which acts the resistance to the hydrogen flow, the primary pressure of the ejector pump 35 is enhanced temporarily. This can increase the ability of the circulation flow of the off gas by the ejector pump 35, and it is thereby possible to rapidly replace the initial gas in the hydrogen electrode of the fuel cell 10 with the hydrogen gas. Further, it is possible to prevent that an excess pressure is applied to the fuel cell 10 by limiting the opening time of the shut valve 40 mounted on the bypass 39 to the predetermined time that is set in advance.

### Fifth Embodiment

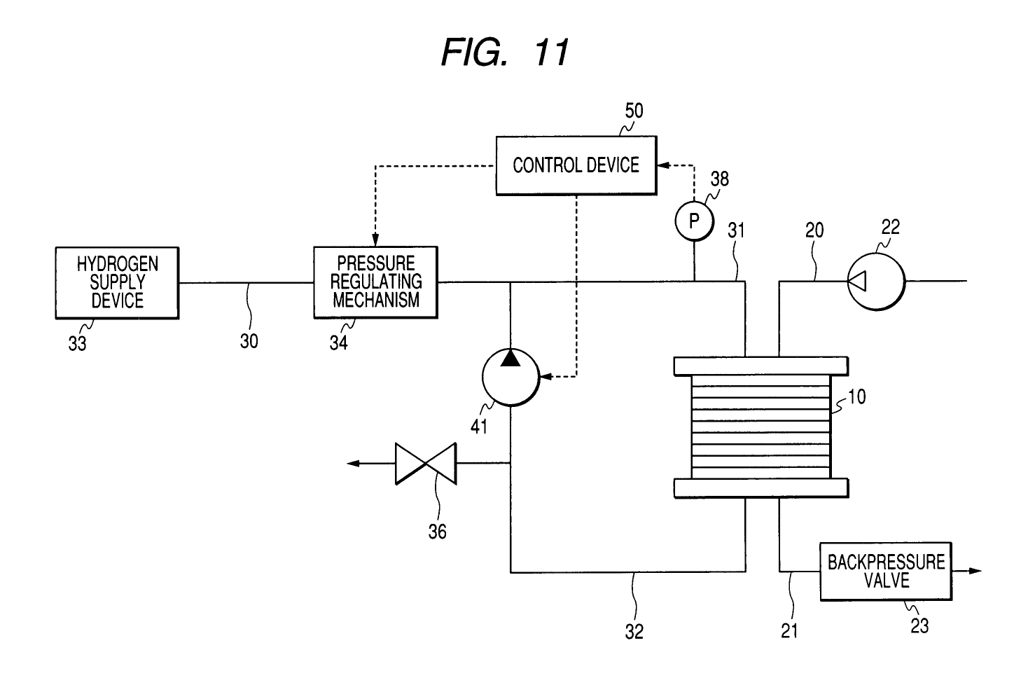

Next, a description will now be given of a configuration and operation of the fuel cell system according to the fifth embodiment of the present invention with reference to FIG. 11.

FIG. 11 is a schematic diagram showing the fuel cell system according to the fifth embodiment of the present invention. When compared with the configuration of the second embodiment, the configuration of the fuel cell system of the fifth embodiment includes an off gas circulation pump 41, instead of the ejector pump 35 incorporated in the fuel cell system of the second embodiment. The off gas circulation pump 41 acts as the off gas circulation means for circulating the off gas through the off gas circulation path 32. The off gas circulation pump 41 has a maximum flow amount of 300 NL/min. The control device 50 generates and transfers a control signal to the off gas circulation pump 41. When receiving the control signal from the control device 50, the off gas circulation pump 41 is configured to change or regulate the circulation flow amount of the off gas. The pressure regulating mechanism 34 of the fifth embodiment is capable of changing or regulating the hydrogen supply pressure within 100 to 300 kPa·abs.

The pressure regulating mechanism 34, the off gas circulation pump 41 and the control device 50 correspond to the circulation ratio adjusting means defined in claims.

In the fuel cell system of the fifth embodiment, before performing the pre-process for the electric generation, the off gas circulation pump 41 operates its maximum flow amount of 300 NL/min.

In order to set the circulation ratio B/A within a predetermined range of 0.2 to 1.0, it is necessary to supply to the fuel cell 10 the hydrogen gas with the flow amount of 300 to 1500 NL/min. Because the off gas circulation pump 41 in the fifth embodiment has the flow amount of the off gas circulation of 300 NL/min, it is necessary to set the flow amount of the hydrogen gas to 600 NL/min in order to supply the hydrogen gas to the fuel cell 10 while keeping the circulation ratio B/A of 0.5. In order to satisfy the above condition, the fifth embodiment gradually increases the hydrogen supply pressure of the pressure regulating mechanism 34 at a predetermined rise factor. In the fifth embodiment, the total volume of the circulation paths 31 and 32, namely the second hydrogen supply path 31 including the fuel cell 10 and the off gas circulation path 32 is 10 liters. Accordingly, before performing the pre-process for the electric generation, the pressure regulating mechanism 34 of the fifth embodiment gradually increases the hydrogen supply pressure of the hydrogen gas to 300 kPa·abs with a rise factor of 100 kPa/min (=600 NL/min/10 L×100 kPa/60 sec in order to obtain the hydrogen supply amount of 600 NL/min and to keep the circulation ratio B/A of 0.5. After the pre-process is performed for a predetermined time, the pre-process is stopped and the usual electric generation is initiated.

In the fuel cell system of the fifth embodiment, the pre-process for the electric generation is initiated while circulating the off gas at the maximum flow amount by the off gas circulation pump 41, supplying the hydrogen gas from the hydrogen supply device 33, and increasing the hydrogen supply pressure with the rise factor 100 kPa·abs. The pre-process for the electric generation is stopped when the pressure of the second hydrogen supply path 31 detected by the pressure sensor 38 reaches to 300 kPa·abs, and then the usual electric generation process is initiated.

As described above, according to the configuration and operation of the fuel cell system of the fifth embodiment, like the first to fourth embodiments, it is possible to replace the initial gas in the hydrogen electrode of the fuel cell 10 with the hydrogen gas while preventing the emission or exhaustion of the initial gas such as nitrogen rich gas to the outside of the fuel cell system, and thereby possible to initiate the electric generation of the fuel cell 10 in a short time.

In addition, according to the configuration of the fuel cell system of the fifth embodiment, because the off gas circulation pump 41 is mounted on the off gas circulation path 32, the off gas is circulated certainly under a condition of a low supply amount of the hydrogen gas to the fuel cell 10. Further, it is possible to set the circulation ratio B/A within a predetermined range by limiting the flow amount of the hydrogen gas to the fuel cell 10 by gradually increasing the hydrogen supply pressure by the pressure regulating mechanism 34 when the off gas circulation pump 41 operates at the maximum flow amount.

### Sixth Embodiment

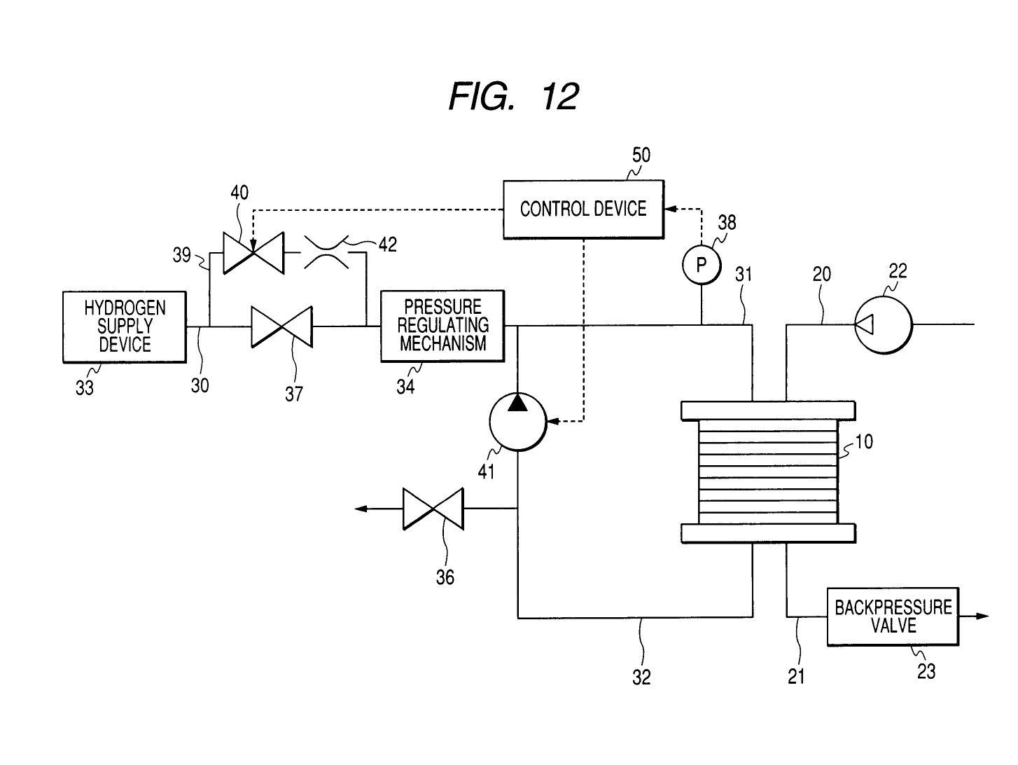

Next, a description will now be given of a configuration and operation of the fuel cell system according to the sixth embodiment of the present invention with reference to FIG. 12.

FIG. 12 is a schematic diagram showing the fuel cell system according to the sixth embodiment of the present invention. When compared with the configuration of the fuel cell system of the fifth embodiment, the fuel cell system of the sixth embodiment is equipped with a shut valve 37 in the first hydrogen supply path 30 and the bypass 39 for bypassing the shut valve 37 is mounted on the first hydrogen supply path 30. An orifice 42 is mounted on the bypass 39. The orifice 42 is capable of decreasing the sectional area of the flow path composed of the shut valve 40 and the bypass 39.

In the sixth embodiment, the pressure regulating mechanism 34 is configured to set the hydrogen supply pressure to a fixed value (300 kPa·abs), and the maximum flow amount of the off gas circulation pump 41 is 200 NL/min.

The pressure regulating mechanism 34, the off gas circulation pump 41, the orifice 42, and the control device 50 correspond to the circulation ratio adjusting means defined in claims.

In the fuel cell system of the sixth embodiment, before performing the pre-process for the electric generation, the off gas circulation pump 41 operates at the maximum flow amount of 200 NL/min. In order to set the circulation ratio B/A within a predetermined range of 0.2 to 1.0, it is necessary to supply to the fuel cell 10 the hydrogen gas with the flow amount of 200 to 1000 NL/min. Because the off gas circulation pump 41 in the sixth embodiment has the flow amount of the off gas circulation of 200 NL/min, it is necessary to set the flow amount of the hydrogen gas to 1000 NL/min in order to supply the hydrogen gas to the fuel cell 10 while keeping the circulation ratio B/A of 0.2.

In the configuration of the fuel cell system of the sixth embodiment, the hydrogen supply amount becomes not less than 1000 NL/min and the circulation ratio B/A thereby becomes not more than 0.2 when the hydrogen gas is supplied to the fuel cell 10 through the first hydrogen supply path 30 and the second hydrogen supply path 31. In order to avoid this, the sixth embodiment has the shut valve 37 mounted on the first hydrogen supply path 30 so as to flow the hydrogen gas supplied from the hydrogen supply device 33 only through the bypass 39 during the pre-process for the electric generation, and the sixth embodiment further has the orifice 42 mounted on the bypass 39 capable of limiting the flow area of the bypass 39 in order to limit the hydrogen supply flow amount to the fuel cell 10. The diameter of the orifice 42 is so set that the maximum flow amount of the hydrogen gas supply becomes 1000 NL/min.

In the configuration of the sixth embodiment, while circulating the off gas at the maximum flow amount by the off gas circulation pump 41, the shut valve 37 is closed and the shut valve 40 mounted on the bypass 39 is opened, and the hydrogen supply from the hydrogen supply device 33 is initiated and the pre-process for the electric generation is thereby initiated. The pre-process for the electric generation is stopped when the pressure of the second hydrogen supply path 31 detected by the pressure sensor 38 reaches to 300 kPa·abs, the shut valve 40 for the bypass 39 is closed, the shut valve 37 mounted on the first hydrogen supply path 30 is opened, and then the usual electric generation process is initiated.

As described above, according to the configuration and operation of the fuel cell system of the sixth embodiment, like the first to fifth embodiments, it is possible to replace the initial gas in the hydrogen electrode of the fuel cell 10 with the hydrogen gas while preventing the emission or exhaustion of the initial gas such as nitrogen rich gas to the outside of the fuel cell system, and thereby possible to initiate the electric generation of the fuel cell 10 at a short time.

In addition, according to the configuration of the fuel cell system of the sixth embodiment, the hydrogen supply flow amount is adjusted or regulated by the orifice mounted on the bypass 39. It is therefore possible to regulate or adjust the hydrogen supply flow amount to the fuel cell 10 during the pre-process for the electric generation with a simple configuration and possible to set the circulation ratio B/A within the predetermined range.

### Seventh Embodiment

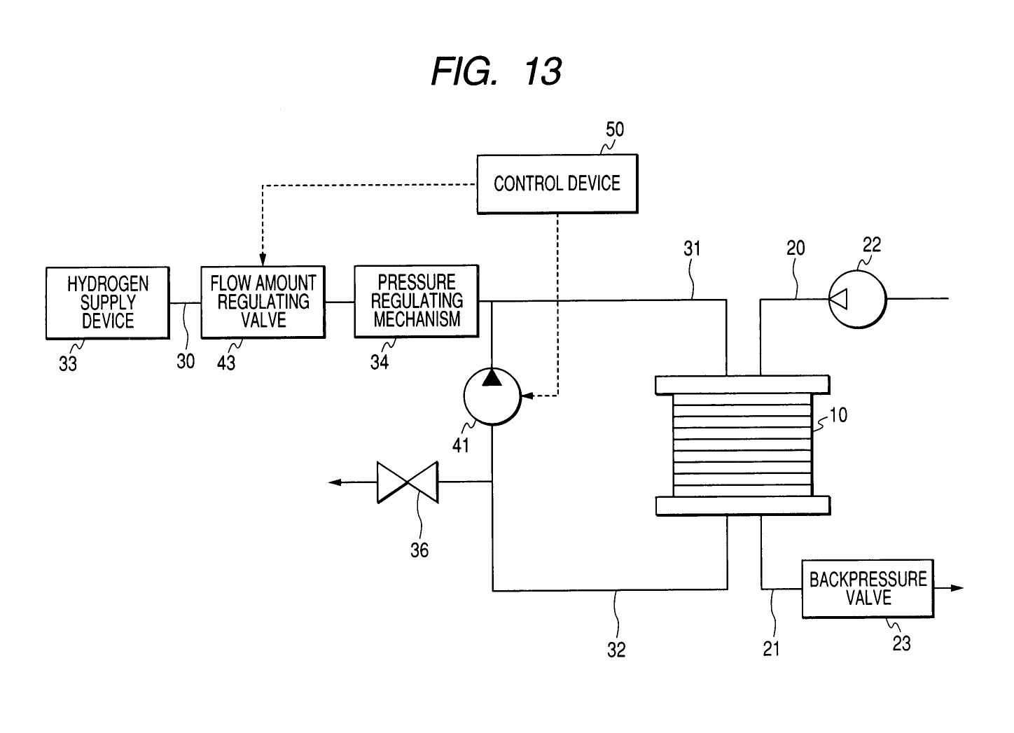

Next, a description will now be given of a configuration and operation of the fuel cell system according to the seventh embodiment of the present invention with reference to FIG. 13.

FIG. 13 is a schematic diagram showing the fuel cell system according to the seventh embodiment of the present invention. As shown in FIG. 13, when compared with the configuration of the fuel cell system of the sixth embodiment, the fuel cell system of the seventh embodiment is equipped with a flow amount regulating valve 43 placed at the upstream end of the pressure regulating mechanism 34 in the first hydrogen supply path 30, instead of the bypass 39 and the orifice 42 used in the sixth embodiment. The seventh embodiment is so configured that the flow amount regulating valve 43 has the maximum flow amount 1000 NL/min of hydrogen gas.

The pressure regulating mechanism 34, the off gas circulation pump 41, the flow amount regulating valve 43, and the control device 50 correspond to the circulation ratio adjusting means defined in claims.

In the seventh embodiment, while the off gas is circulated by the off gas circulation pump 41 at the maximum flow amount under the control of the control device 50, and the hydrogen gas is supplied from the hydrogen supply device 33 at the hydrogen supply flow amount of 1000 NL/min by the flow amount regulating valve 43. The pre-process for the electric generation of the fuel cell is thereby initiated. Thus, the flow amount regulating valve 43 limits the hydrogen supply amount during the pre-process for the electric generation.

When the pressure of the second hydrogen supply path 31 detected by the pressure sensor 38 reaches to 300 kPa·abs, the pre-process for the electric generation is stopped. The hydrogen gas is then supplied at the maximum hydrogen supply amount by the flow amount regulating valve 43 under the control of the control device 50, and the usual electric generation process is then initiated.

Thus, the flow amount regulating valve 43 in the seventh embodiment does not operate or releases from its operation during the usual electric generation process, and the flow amount of the hydrogen gas to be supplied is controlled by the pressure regulating mechanism 34 during the usual electric generation process.

As described above, according to the fuel cell system of the seventh embodiment, like the first to sixth embodiments, it is possible to replace the initial gas in the hydrogen electrode of the fuel cell 10 with the hydrogen gas while preventing the emission or exhaustion of the initial gas such as nitrogen rich gas to the outside of the fuel cell system, and thereby possible to initiate the electric generation of the fuel cell 10 at a short time.

### Eighth Embodiment

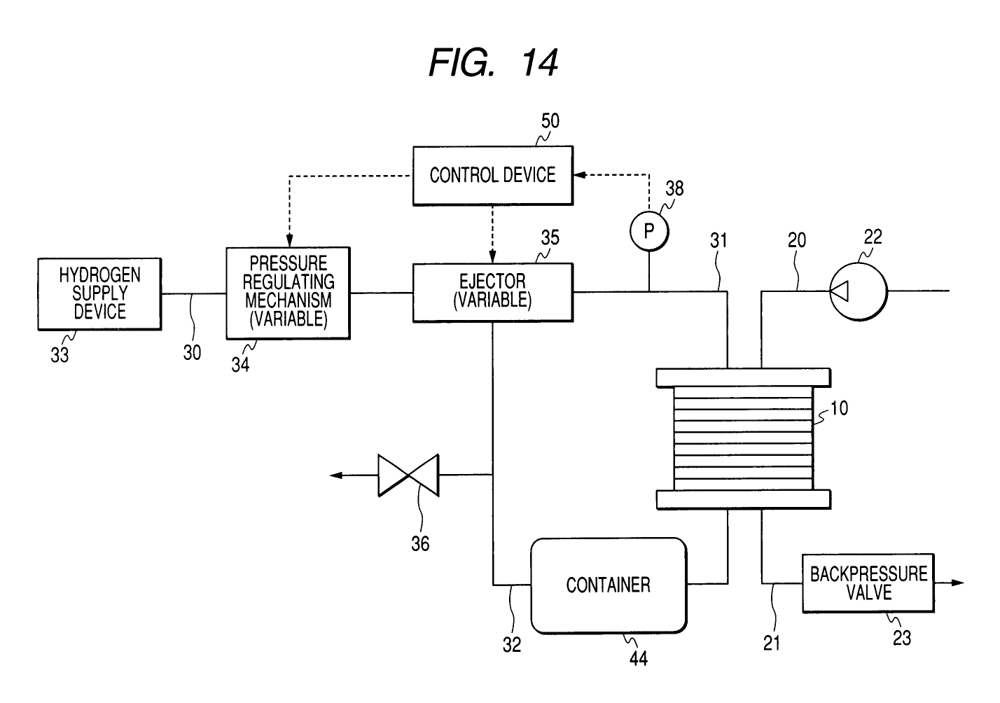

Next, a description will now be given of a configuration and operation of the fuel cell system according to the eighth embodiment of the present invention with reference to FIG. 14 to FIG. 16.

FIG. 14 is a schematic diagram showing the fuel cell system according to the eighth embodiment of the present invention. As shown in FIG. 14, when compared with the configuration of the fuel cell system of the third embodiment shown in FIG. 8, the fuel cell system of the eighth embodiment is equipped with a gas container 44 of a desired volume in the off gas circulation path 32.

The pressure regulating mechanism 34, the ejector pump 35, and the control device 50 correspond to the circulation ratio adjusting means defined in claims.

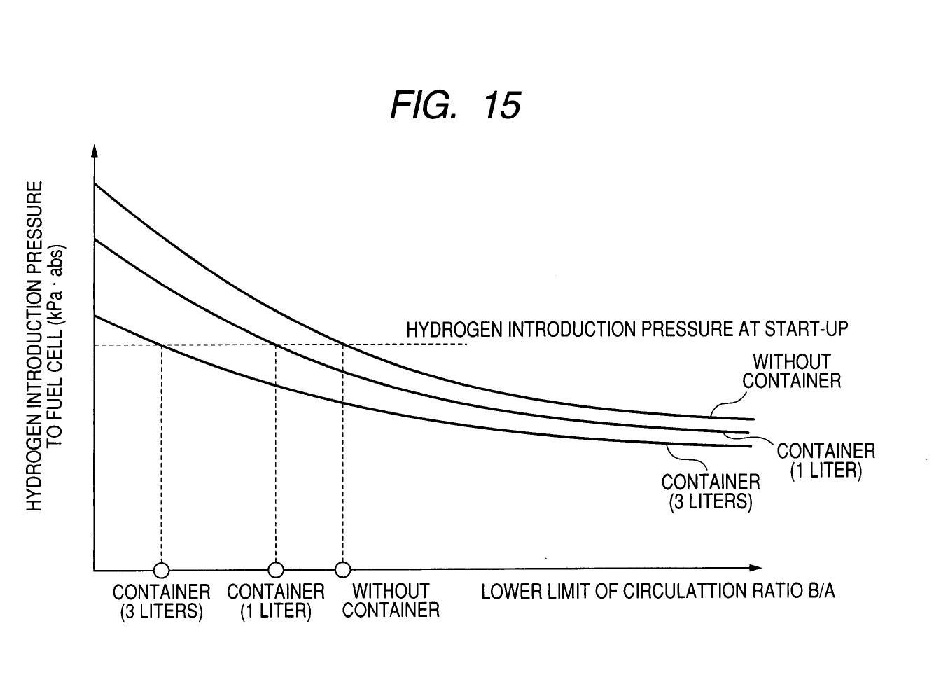

FIG. 15 is a diagram showing a relationship between an introduction pressure of hydrogen gas to be supplied to the fuel cell 10 and a lower limit of the circulation ratio B/A of the hydrogen gas in the fuel cell system according to the eighth embodiment. FIG. 15 show the three cases, the first case does not have the container 44, the second case having the container 44 whose volume is 1 liter, and the third case has the container 44 whose volume is 3 liters on the off gas circulation path 32. As clearly shown in FIG. 15, the presence of the container 44 in the off gas circulation path 32 can decrease the lower limit of the circulation ratio B/A that is necessary for a same hydrogen pressure. Further, as shown in FIG. 15, the increase of the volume of the container 44 can reduce the lower limit of the circulation ratio B/A. The fuel cell system of the eighth embodiment uses or incorporates the container 44 of 1 liter in order to set the lower limit of the circulation ratio B/A to 0.1.

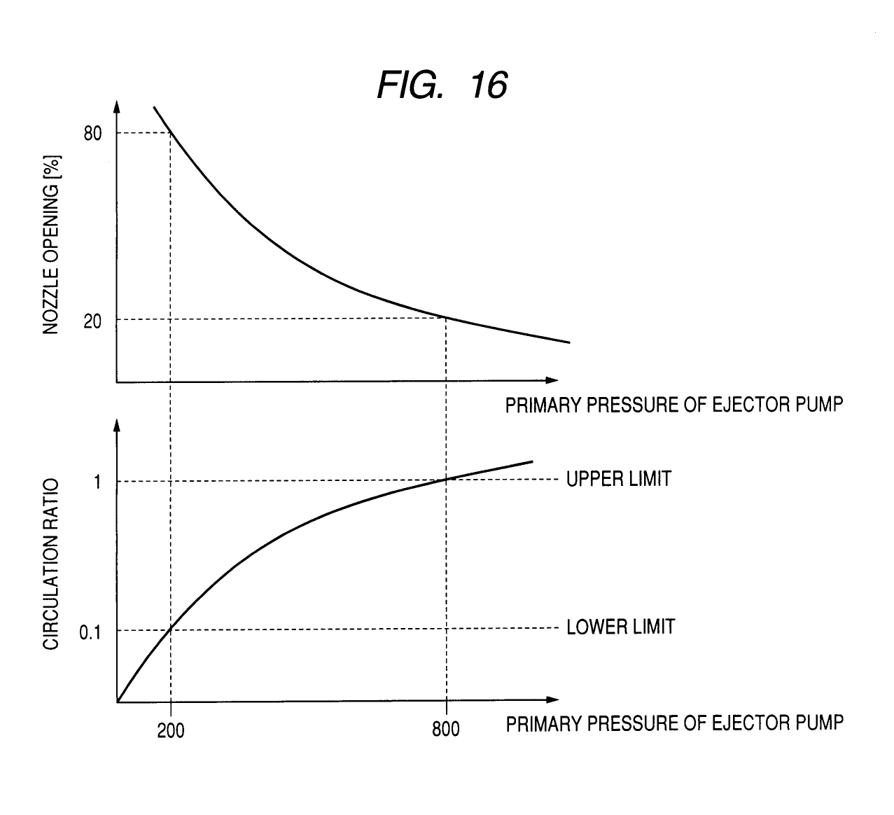

FIG. 16 is a diagram showing a relationship between the nozzle opening and a primary pressure of the ejector pump 35, and a relationship between the primary pressure of the ejector pump 35 and the circulation ratio B/A in the fuel cell system according to eighth embodiment. FIG. 16 shows the case where the fuel gas is supplied to the fuel cell 10 at the gas introduction amount is 500 NL/min.

As shown in FIG. 16, in order to set the circulation ratio B/A within a predetermined range of 0.1 to 1.0, it is necessary to set the primary pressure of the ejector pump 35 within 200 to 800 kPa·abs. Further, in order to set the fuel gas introduction amount to 500 NL/min when the primary pressure of the ejector pump 35 is within 200 to 800 kPa·abs, it is necessary to set the nozzle opening of the ejector pump 35 within 20 to 80 percentages.

In the fuel cell system of the eighth embodiment, the pressure regulating mechanism 35 sets the primary pressure of the ejector pump 35 to 300 kPa·abs and the nozzle opening of the ejector pump is set to 60 percent. The supply of the hydrogen gas from the hydrogen supply device 33 is then started. The pre-process for the electric generation is thereby initiated. After the elapse of the predetermined time period counted from the initiation of the pre-process for the electric generation, the pre-process is stopped. The nozzle opening of the ejector pump 35 is decreased and the pressure regulating mechanism 34 decreases its hydrogen supply pressure, and the primary pressure of the ejector pump 35 is set to 300 kPa·abs, and the fuel cell 10 thereby initiates the usual electric generation operation.

As described above, according to the fuel cell system of the eighth embodiment, like the first to seventh embodiments, it is possible to replace the initial gas in the hydrogen electrode of the fuel cell 10 with the hydrogen gas while preventing the emission or exhaustion of the initial gas such as nitrogen rich gas to the outside of the fuel cell system, and thereby possible to initiate the electric generation of the fuel cell 10 in a short time.

As explained in the eighth embodiment, the presence of the container 44 having a predetermined volume in the off gas circulation path 32 can decrease the off gas circulation capability, for circulating the off gas, of the off gas circulation means, composed of the pressure regulating mechanism 34 and the ejector pump 35.

### Other Preferred Embodiments

The concept of the fuel cell system according to the present invention is not limited by the first to eighth embodiments described above. It is possible to combine the configurations of the fuel cell system of the first to eighth embodiments. Various modifications obtained by combining the first to eighth embodiments have the same effects of the present invention.

### Features and Effects of the Present Invention

As described above in detail, the fuel cell system according to the present invention mainly has a fuel cell, a fuel gas supply path, an of gas circulation path, an off gas circulation unit, and a circulation ratio adjusting unit. The fuel cell is configured to generate electric generation in electrochemical reaction by combining fuel gas and oxygen gas. The fuel gas supply path is joined to an inlet of the fuel cell. Through the fuel gas supply path, the fuel gas is supplied to the fuel cell. The off gas circulation path joins an outlet of the fuel cell to the fuel gas supply path. Through the outlet of the fuel cell, an off gas in a fuel electrode of the fuel cell is exhausted. The off gas circulation means is configured to circulate the off gas from the fuel electrode of the fuel cell to the fuel gas supply path. The circulation ratio adjusting means is configured to adjust a circulation ratio of a mole flow of the fuel gas to a mole flow of the off gas by controlling at least one of a fuel gas flow amount and an off gas flow amount so that the circulation ratio is set to a predetermined circulation ratio during a pre-process for the electric generation of the fuel cell in order to exhaust all of residual gas in the fuel electrode of the fuel cell remained before initiating the pre-process.

According to the configuration of the fuel cell system of the present invention, it is possible to replace initial gas in the fuel electrode (such as hydrogen electrode) of the fuel cell, that is remained in the fuel electrode before the pre-process, with the fuel gas (such as hydrogen gas) while circulating the initial gas, through the off gas circulation path and while preventing the emission or exhaustion of the initial gas such as nitrogen rich gas to the outside of the fuel cell system. It is thereby possible to initiate the electric generation of the fuel cell at a short time. This can prevent that the fuel gas is exhausted to the outside of the fuel cell system even if the fuel gas is remained in the fuel electrode immediately following the halt of the electric generation.

The lower limit of the predetermined range of the circulation ratio is set to a value by which all of gases in the fuel electrode of the fuel cell is exhausted from the fuel electrode of the fuel cell by introducing the fuel gas to the fuel cell before initiating the pre-process for the electric generation. This can prevent unstable electric generation caused by the presence of residual initial gas in the fuel electrode before the electric generation.

The lower limit of the circulation ratio is determined based on the volume of the fuel gas supply path including the volume of the fuel electrode in the fuel cell, the volume of the off gas circulate path, and a supply pressure of the fuel gas to be supplied to the fuel cell when the pre-process is initiated.

Further, according to the fuel cell system as defined in the present invention, the upper limit of the predetermined range of the circulation ratio is set to a value which corresponds to a gas concentration of the mixed gas composed of the off gas and the fuel gas to be supplied to the fuel cell, necessary for performing the electric generation. This can prevent any occurrence of insufficient concentration of the fuel gas in the mixed gas and further prevent unstable electric generation of the fuel cell.

Still further, according to the fuel cell system as defined in the present invention, the circulation ratio adjusting means is mounted on a joint point at which the off gas circulation path is joined to the fuel gas supply path. The circulation ratio adjusting means has the ejector pump having the nozzle that ejects the fuel gas in order to suck the off gas, to mix the fuel gas and the off gas, and to discharge the mixed gas. The circulation ratio adjusting means adjusts the nozzle opening of the nozzle in order to regulate the mixed ratio of the fuel gas and the off gas. The circulation ratio adjusting means regulates the nozzle opening of the nozzle of the ejector pump in order to set the circulation ratio within the predetermined range when the pre-process of the electric generation is performed. Thus, even if the supply pressure of the fuel gas to the ejector pump is constant, it is possible to set the circulation ratio to an optimum value by adjusting the off gas flow amount while regulating the flow amount of the fuel gas by adjusting the nozzle opening of the ejector pump.

Still further, according to the fuel cell system as defined in the present invention, the circulation ratio adjusting means is mounted on a joint point at which the off gas circulation path is joined to the fuel gas supply path. The circulation ratio adjusting means has the ejector pump and the pressure regulating mechanism. The ejector pump has the nozzle that ejects the fuel gas in order to suck the off gas. The ejector pump mixes the fuel gas and the off gas and discharges the mixed gas. The pressure regulating mechanism, placed at upstream end of the ejector pump in the fuel gas supply path, is capable of regulating the fuel gas supply pressure. The pressure regulating mechanism regulates the fuel supply pressure of the fuel gas in order to set the circulation ratio within the predetermined range when the pre-process of the electric generation is performed.

It is thereby possible to regulate the off gas circulation flow amount by changing the fuel gas supply pressure under the control of the pressure regulating mechanism even if the fuel gas flow amount is constant, and possible to adjust the circulation ratio to the optimum value.

Still furthermore, the fuel cell system as defined in the present invention has the bypass configured to bypass a part of the fuel gas flowing through the fuel gas supply path and the open and close valve configured to open and close the bypass. The open and close valve is opened when the pre-process of the electric generation is performed. It is thereby possible to temporarily increase the fuel gas supply pressure to the ejector pump in order to enhance the off gas circulation capability.

In addition, according to the fuel cell system as defined in the present invention, the ejector pump is configured to regulate a mixing ratio of the fuel gas and the off gas by adjusting its nozzle opening.

Further, according to the fuel cell system as defined in the present invention, it is possible to avoid occurrence of applying excess pressure, namely increased gas pressure, to the fuel cell by opening the open and close valve for a predetermined time.

Still furthermore, according to the fuel cell system as defined in the present invention, the predetermined time is set to a time by which the pressure of the fuel gas in the fuel gas supply path reaches a pressure necessary for initiating the electric generation of the fuel cell. The predetermined time is set based on the volume of the fuel electrode in the fuel cell, the volume of the downstream end of the fuel gas supply path from the joint point between the fuel gas supply path and the off gas circulation path, the volume of the off gas circulation path, and the supply amount of the fuel gas to the fuel cell.

Still furthermore, the fuel cell system according to the present invention further has the pressure detection means configured to detect one of a pressure in the path at the downstream end of the joint point between the fuel gas supply path and the off gas circulation path and a pressure in the off gas circulation path. The open and close valve is opened until the pressure in the fuel gas supply path detected by the pressure detection means is over a predetermined value. It is thereby possible to prevent occurrence of excess pressure, namely increased gas pressure to the fuel cell.

Further, according to the fuel cell system as defined in the present invention, the circulation ratio adjusting means has the off gas circulation pump and the pressure regulating mechanism. The off gas circulation pump is configured to forcedly supply the off gas in the off gas circulation path. The pressure regulating mechanism is configured to regulate a supply pressure of the fuel gas in the fuel gas supply path. The circulation ratio adjusting means operates the off gas circulation pump and instructs the pressure regulating mechanism to increase the supply pressure of the fuel gas at a predetermined rise factor in order to satisfy the circulation ratio within a predetermined range while performing the pre-process for the electric generation. It is thereby possible to set the circulation ratio within a predetermined range by gradually increasing the fuel gas supply pressure by the pressure regulating mechanism in order to limit the hydrogen gas supply amount to the fuel cell.

Still further, according to the fuel cell system as defined in the present invention, the circulation ratio adjusting means has the off gas circulation pump, the pressure regulating mechanism, the first open and close valve, the bypass, the second open and close valve, and the orifice. The off gas circulation pump is configured to forcedly supply the off gas in the off gas circulation path. The pressure regulating mechanism is configured to set a supply pressure of the fuel gas in the fuel gas supply path to a predetermined pressure value. The first open and close valve is placed in the upstream end of the pressure regulating mechanism in the fuel gas supply path. The first open and close valve is configured to open and close the fuel gas supply path. Through the bypass, the fuel gas flowing through the fuel gas supply path bypasses the first open and close valve. The second open and close valve is configured to open and close the bypass. The orifice is configured to decrease a sectional flow area of the bypass. The circulation ratio adjusting means controls that the first open and close valve is closed and the second open and close valve is opened while actuating the off gas circulation pump in the pre-process for the electric generation. It is therefore possible to regulate the flow amount of the fuel gas by changing the diameter of the orifice capable of decreasing a sectional flow area, and thereby to set the circulation ratio within a predetermined range.

Moreover, according to the fuel cell system as defined in the present invention, the second open and lose valve is configured to open for a predetermined time. The predetermined time is set to a time by which the pressure of the fuel gas in the fuel gas supply path reaches a pressure necessary for initiating the electric generation of the fuel cell. It is thereby possible to prevent occurrence of excess pressure, namely increased gas pressure to the fuel cell.

Further, the fuel cell system as defined in the present invention further has the pressure detection means that is configured to detect one of a pressure of the fuel gas supply path at a downstream end of the joint point, at which the fuel gas supply path is joined to the off gas circulation path, and a pressure of the off gas circulation path. The second open and close valve is opened until the pressure in the fuel gas supply path detected by the pressure detection means is over a predetermined value. Therefore like the fuel cell system as defined in the present invention, it is thereby possible to prevent occurrence of excess pressure, namely increased gas pressure to the fuel cell.

Still further, according to the fuel cell system as defined in the present invention, the circulation ratio adjusting means has the off gas circulation pump, and the flow amount regulating mechanism. The off gas circulation pump is configured to forcedly supply the off gas in the off gas circulation path. The flow amount regulating mechanism is configured to regulate a flow amount of the fuel gas in the fuel gas supply path. The circulation ratio adjusting means adjusts the fuel gas supply amount to the fuel cell so that the circulation ratio is set within a predetermined range by the flow amount regulating mechanism while actuating the off gas circulation pump in the pre-process for the electric generation. It is thereby possible to set the circulation ratio within a predetermined range by regulating the fuel gas flow amount by the flow amount regulating mechanism.

Moreover, the fuel cell system as defined in the present invention further has the container having a predetermined volume mounted on the upstream end of the off gas circulation means in the off gas circulation path. It is thereby possible to decrease the lower limit of the circulation ratio when the pre-process for the electric generation is performed, so that the circulation capability of the off gas circulation means can be reduced. In other words, it is also possible to use the off gas circulation means of a low circulation capability.

Further, according to the present invention as defined in the present invention, a movable body is equipped with any one of the fuel cell systems defined in the present invention.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A fuel cell system comprising:
a fuel cell configured to generate electric generation in electrochemical reaction by combining fuel gas and oxygen gas;
a fuel gas supply path through which the fuel gas is supplied to an fuel electrode of the fuel cell;
an off gas circulation path, through which an outlet of the fuel electrode of the fuel cell is joined to the fuel gas supply path, configured to provide off gas exhausted from the fuel electrode of the fuel cell to the fuel gas supply path in order to mix the off gas into the fuel gas;
off gas circulation means configured to circulate the off gas through the off gas circulation path; and
circulation ratio adjusting means configured to adjust a circulation ratio of a mole flow of the fuel gas flowing through the fuel gas supply path to a mole flow of the off gas flowing through the off gas circulation path by controlling at least one of the fuel gas flow amount and the off gas flow amount,
wherein the off gas exhausted from the fuel electrode of the fuel cell is supplied to the fuel gas supply path through the off gas circulation path and mixed to the fuel gas and supplied to the fuel cell,
the circulation ratio adjusting means is configured to perform a pre-process, before initiating the electric generation by the fuel cell, in which the fuel gas is supplied to the fuel cell so that the circulation ratio is set to a predetermined circulation ratio and a lower limit of the predetermined circulation ratio is set to a value by which all of remaining gas in the fuel electrode of the fuel cell is exhausted by supplying the fuel gas to the fuel cell before initiating the electric generation of the fuel cell.

2. The fuel cell system according to claim 1, wherein an upper limit of the predetermined circulation ratio is set to a gas concentration of the mixed gas composed of the fuel gas to be supplied to the fuel cell and the off gas by which the fuel cell can perform the electric generation.

3. The fuel cell system according to claim 1, wherein the circulation ratio adjusting means is mounted on a joint point at which the off gas circulation path is joined to the fuel gas supply path, and
the circulation ratio adjusting means comprises an ejector pump having a nozzle that ejects the fuel gas in order to suck the off gas, and the ejector pump mixing the fuel gas and the off gas and discharging the mixed gas, and
the circulation ratio adjusting means adjusts the nozzle opening of the nozzle in order to regulate the mixed ratio of the fuel gas and the off gas, and regulates the nozzle opening of the nozzle of the ejector pump in order to set the circulation ratio within the predetermined range when the pre-process of the electric generation is performed.

4. The fuel cell system according to claim 1, wherein the circulation ratio adjusting means is mounted on a joint point at which the off gas circulation path is joined to the fuel gas supply path, and the circulation ratio adjusting means comprises:
an ejector pump having a nozzle that ejects the fuel gas in order to suck the off gas, and the ejector pump mixing the fuel gas and the off gas and discharging the mixed gas; and
a pressure regulating mechanism, placed at upstream end of the ejector pump in the fuel gas supply path, capable of regulating the fuel gas supply pressure in order to set the circulation ratio within the predetermined range when the pre-process of the electric generation is performed.

5. The fuel cell system according to claim 4, further comprising:
a bypass configured to bypass a part of the fuel gas flowing through the fuel gas supply path; and
an open and close valve configured to open and close the bypass,
wherein the open and close valve is opened when the pre-process of the electric generation is performed.

6. The fuel cell system according to claim 4, wherein the ejector pump is capable of regulating the mixed ratio of the fuel gas and the off gas by adjusting the opening of the nozzle.

7. The fuel cell system according to claim 5, wherein the open and close valve is opened for a predetermined time.

8. The fuel cell system according to claim 7, wherein the predetermined time is set to a time by which the pressure of the fuel gas in the fuel gas supply path reaches a pressure necessary for initiating the electric generation of the fuel cell.

9. The fuel cell system according to claim 5, further comprising pressure detection means configured to detect one of a pressure in the path at the downstream end of the joint point between the fuel gas supply path and the off gas circulation path and a pressure in the off gas circulation path, and wherein
the open and close valve is opened until the pressure in the fuel gas supply path detected by the pressure detection means is over a predetermined value.

10. The fuel cell system according to claim 1, wherein the circulation ratio adjusting means comprises:
an off gas circulation pump configured to forcedly supply the off gas in the off gas circulation path; and
a pressure regulating mechanism configured to regulate a supply pressure of the fuel gas in the fuel gas supply path, and
wherein the circulation ratio adjusting means operates the off gas circulation pump and instructs the pressure regulating mechanism to increase the supply pressure of the fuel gas at a predetermined rise factor in order to set the circulation ratio within a predetermined range while performing the pre-process for the electric generation.

11. The fuel cell system according to claim 1, wherein the circulation ratio adjusting means comprises:
an off gas circulation pump configured to forcedly supply the off gas in the off gas circulation path;
a pressure regulating mechanism configured to set a supply pressure of the fuel gas in the fuel gas supply path to a predetermined pressure value;
a first open and close valve, placed at the upstream end of the pressure regulating mechanism in the fuel gas supply path, configured to open and close the fuel gas supply path at the upstream end of the pressure regulating mechanism;
a bypass configured to bypass the first open and close valve on the fuel gas supply path;
a second open and close valve configured to open and close the bypass; and
an orifice configured to decrease a sectional flow area of the bypass, and wherein
the circulation ratio adjusting means controls that the first open and close valve is closed and the second open and close valve is opened while actuating the off gas circulation pump in the pre-process for the electric generation.

12. The fuel cell system according to claim 11, wherein the second open and close valve is configured to open for a predetermined time, and the predetermined time is set to a time by which the pressure of the fuel gas in the fuel gas supply path reaches a pressure necessary for initiating the electric generation of the fuel cell.

13. The fuel cell system according to claim 11, further comprising pressure detection means configured to detect one of a pressure of the fuel gas supply path at a downstream end of the joint point, at which the fuel gas supply path is joined to the off gas circulation path, and a pressure of the off gas circulation path, wherein
the second open and close valve is opened until the pressure in the fuel gas supply path detected by the pressure detection means is over a predetermined value.

14. The fuel cell system according to claim 1, wherein the circulation ratio adjusting means comprises:
an off gas circulation pump configured to forcedly supply the off gas in the off gas circulation path; and
a flow amount regulating mechanism configured to regulate a flow amount of the fuel gas in the fuel gas supply path,
wherein the circulation ratio adjusting means adjusts the fuel gas supply amount to the fuel cell so that the circulation ratio is set within a predetermined range by the flow amount regulating mechanism while actuating the off gas circulation pump in the pre-process for the electric generation.

15. The fuel cell system according to claim 1, further comprising a container having a predetermined volume mounted on an upstream end of the off gas circulation means in the off gas circulation path.

16. A movable body equipped with the fuel cell system according to claim 1.

17. A fuel cell system comprising:
a fuel cell configured to generate electric generation in electrochemical reaction by combining fuel gas and oxygen gas;
a fuel gas supply path, joined to an inlet of the fuel cell, through which the fuel gas is supplied to the fuel cell;
an off gas circulation path joining to the fuel gas supply path an outlet of the fuel cell through which an off gas in an fuel electrode of the fuel cell being exhausted;
off gas circulation means configured to circulate the off gas from the fuel electrode of the fuel cell to the fuel gas supply path; and
circulation ratio adjusting means configured to adjust a circulation ratio of a mole flow of the fuel gas to a mole flow of the off gas by controlling at least one of a fuel gas flow amount and an off gas flow amount so that the circulation ratio is set to a predetermined circulation ratio during a pre-process for the electric generation of the fuel cell in order to exhaust all of residual gas in the fuel electrode of the fuel cell remained before initiating the pre-process.

18. A method of performing a pre-process for electric generation in a fuel cell system equipped with a fuel cell, comprising steps of:
performing a pre-process, before initiating usual electric generation of the fuel cell, the pre-process comprising steps of:
mixing off gas emitted from a fuel electrode of the fuel cell to fuel gas to be supplied to the fuel gas; and
supplying the mixed gas to the fuel cell at a predetermined circulation ratio while adjusting at least one of a fuel gas flow amount and an off gas flow amount in order to exhaust all of residual gas in the fuel electrode of the fuel cell remained before initiating the pre-process, where the circulation ratio is a ratio of a mole flow of the fuel gas to a mole flow of the off gas, and
performing the usual electric generation after the completion of the pre-process.
